(19) United States
(12) Patent Application Publication
(10) Pub. No.: US 2007/0188584 A1
(43) Pub. Date: Aug. 16, 2007

(54) IMAGE FORMING APPARATUS

(75) Inventors: Tetsurou Nakamura, Hyogo (JP); Kei Sakanoue, Fukuoka (JP); Yuuji Toyomura, Fukuoka (JP); Ryuuichi Yatsunami, Fukuoka (JP); Takafumi Hamano, Fukuoka (JP); Naoto Matsuo, Fukuoka (JP); Shinya Yamamoto, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/673,267

(22) Filed: Feb. 9, 2007

(30) Foreign Application Priority Data
Feb. 13, 2006 (JP) 2006/034832
Apr. 27, 2006 (JP) 2006/123750

(51) Int. Cl. B41J 2/385

(52) U.S. Cl. 347/133

(57) ABSTRACT

An image forming apparatus includes a photoconductor 8 which bears an image to be formed by exposure, a light emission part 600 which emits light for exposing the photoconductor 8 to the light, and a light quantity measuring part 700 which measures the quantity of the light emitted from the light emission part 600 and outputs a light quantity measuring signal. The light quantity measuring signal of the light quantity measuring part 700 is sent through an engine control part 42 to a controller 41, and the quantity of the light emitted from the light emission part 600 is controlled so that the light quantity measuring signal becomes a predetermined value. Here, a sign indicating inclination (change rate) of the light quantity measuring signal of the light quantity measuring part 700 for temperature is matched with a sign indicating inclination (change rate) of sensitivity of the photoconductor 8 for temperature.

### BACKGROUND

The present invention relates to an image forming apparatus which forms a picture image by means of an image formed by exposure.

Various image forming apparatuses which apply an electrophotographic process have been realized.

As exposure means (hereinafter referred to as an exposure unit in case that a form on structure of the image forming apparatus is described) used in this kind of image forming apparatus, the following two have been known: exposure means which scans light beams that has a laser diode as a light source, on a photoconductor through a polygon mirror thereby to form an electrostatic latent image; and exposure means which uses a light emitting element array in which light emitting elements each of which is composed of a light emitting diode (hereinafter referred to as LED) or organic electroluminescence material are arranged linearly, and controls ON/OFF of each light emitting element individually, thereby to form an electrophotographic latent image on a photoconductor.

Particularly, in an exposure unit which mounts an organic electroluminescence element as the light emitting element, a logic circuit and a drive circuit each of which is composed of a switching element composed of a thin film transistor (thereafter referred to as TFT) formed on a substrate such as a glass substrate, and the organic electroluminescence element can be formed integrally. Therefore, structure and a manufacture process are simple, and compared with an exposure unit which mounts a LED as the light emitting element, there is possibility that more size reduction and more cost reduction can be realized.

As technology in which this organic electroluminescence element formed in the shape of an array is applied to the exposure unit, technology disclosed in, for example, JP-A-2002-144634 has been known.

The exposure unit in JP-A-2002-144634 has a picture element including a light emitting element which applies an organic electroluminescence element and a light receiving element on a board, and monitors in the image forming time the light emitted from the light emitting element by the light receiving element, and an image forming apparatus which mounts its exposure unit controls output light intensity of the light emitting element. Therefore, since the image forming apparatus in JP-A-2002-144634 is able to keep the light emission amount of the light emitting element uniform, the image forming apparatus can always form an image having high quality without being affected by variation per time and variation in environment such as temperature.

However, it has been known that the density of an electrostatic latent image obtained by exposing a photoconductor to light has temperature dependence and varies by the temperature even in case that the exposure amount is constant.

FIG. 17 shows an example of relation between temperature and sensitivity of a photoconductor. The photoconductor which we say here is a so-called organic photoconductor (in the following description, simply referred to as a photoconductor) in which a charge generation layer and a charge transport layer (both layers are not shown) are laminated on a substrate such as an aluminum substrate and at least the charge transport layer is composed of an organic matter.

In FIG. 17, a horizontal axis indicates environmental temperature and a vertical axis indicates sensitivity of the photoconductor. In the sensitivity which we say here, some indexes can be used, such as change amount in surface potential of the photoconductor when light having the predetermined light quantity (predetermined energy in case that the light quantity is specified by time) is applied onto an image surface of the photoconductor which has been previously charged with the predetermined potential, change amount in area surrounded by the specified equipotential lines when a light spot having the predetermined size is formed on the image surface of the photoconductor, change amount in weight of toner which is transferred and born on the photoconductor, and change amount in image density which changes with this change of the toner weight. In this case, any index may be used.

The sensitivity of the photoconductor has the definite temperature characteristic, and has generally a tendency to increase with increase of temperature. Namely, as the temperature increases more, the latent image is easier to be formed on the photoconductor, and the density of the obtained image becomes darker. It is thought that the change in sensitivity with the increase of temperature is produced because charge mobility in the charge transport layer (not shown) mainly constituting the photoconductor changes according to the temperature.

Thus, since the photoconductor has the temperature characteristic, even in case that the light quantity of the light emission source is controlled constantly by means of the constitution disclosed in, for example, the Patent Document 1, the density of the obtained image varies by the temperature.

The invention has been made in view of the above circumstances, and it is an object of the invention to provide an image forming apparatus which can suppress variation in image density regardless of surrounding temperature change.

### SUMMARY

An image forming apparatus of the invention includes an image bearing body which bears an image to be formed by exposure; a light emission part which emits light for exposing the image bearing body to the light; a light quantity measuring part which measures the quantity of the light emitted by the light emission part and outputs a light quantity measuring signal; and a correction part which corrects the light quantity measuring signal so as to reduce a difference between a change rate of the image density of the image bearing body for temperature, and a change rate of the light quantity measuring signal of the light quantity measuring part for temperature.

According to the invention, even in case that there is a variation in the surrounding temperature, temperature characteristics of the image bearing body and the light quantity measuring part act in a direction where they offset each other, whereby a variation in image density in relation to the temperature change can be suppressed. Further, even in case that a change rate of the light quantity measuring signal with the temperature change differs greatly from a change rate of the image density with the temperature change, the variation in image density can be suppressed.

An image forming apparatus of the invention includes an image bearing body which bears an image to be formed by exposure; a light emission part which emits light for exposing the image bearing body to the light; a light quantity measuring part which measures the quantity of the light emitted by the light emission part and outputs a light quantity measuring signal; and a correction part which corrects the light quantity measuring signal so as to reduce a difference between a change rate of the image density of the image bearing body for temperature, and a change rate of the light quantity measuring signal of the light quantity measuring part for temperature. Hereby, even in case that there is a variation in the surrounding temperature, temperature characteristics of the image bearing body and the light quantity measuring part act in a direction where they offset each other, whereby a variation in image density in relation to the temperature change can be suppressed. Further, even in case that a change rate of the light quantity measuring signal with the temperature change differs greatly from a change rate of the image density with the temperature change, the variation in image density can be suppressed.

Further, an image forming apparatus of the invention includes an image bearing body which bears an image to be formed by exposure; a light emission part which emits light for exposing the image bearing body to the light; a light quantity measuring part which measures the quantity of the light emitted by the light emission part; and a light quantity control part which controls the quantity of the light emitted by the light emission part so that a value of the light quantity measuring signal outputted by the light quantity measuring part becomes a predetermined value, wherein the image bearing body and the light quantity measuring part are constituted so that temperature characteristics of them are offset by each other. Hereby, even in case that there is a variation in the surrounding temperature, temperature characteristics of the image bearing body and the light quantity measuring part act in a direction where they offset each other, whereby a variation in image density in relation to the temperature change can be suppressed.

Further, an image forming apparatus of the invention includes an image bearing body which bears an image to be formed by exposure; a light emission part which emits light for exposing the image bearing body to the light; a light quantity measuring part which measures the quantity of the light emitted by the light emission part and outputs a light quantity measuring signal; and a light quantity control part which controls the quantity of the light emitted by the light emission part so that a value of the light quantity measuring signal outputted by the light quantity measuring part becomes a predetermined value, wherein a sign indicating a change rate of the light quantity measuring signal of the light quantity measuring part for temperature coincides with a sign indicating a change rate of the density of a picture image formed by the image born by the image bearing body for temperature. Hereby, regardless of the change in surrounding temperature, the variation in image density can be suppressed. For example, in case that both of the sign indicating the change rate of the light quantity measuring signal and the sign indicating the change rate of the image density are positive, the value of the light quantity measuring signal becomes larger than the actual light quantity with the increase of temperature. Therefore, the light quantity control part recognizes that the light quantity of the light emission part has increased, and controls the light quantity so that the emitted light quantity decreases. Since the image bearing body has the characteristic that the image density by the image bearing body becomes also high with the increase of temperature, the increase of density is suppressed by the decrease of the emitted light quantity, with the result that the variation in image density with the temperature change can be suppressed.

### BRIEF DESCRIPTION OF DRAWINGS

FIG. 1 is a constitutional view of an image forming apparatus according to a first embodiment of the invention.

FIG. 2 is a diagram showing the constitution around a development station in the image forming apparatus according to the first embodiment of the invention.

FIG. 3 is a diagram showing the constitution of an exposure unit in the image forming apparatus according to the first embodiment of the invention.

FIGS. 4(a) and 4(b) are diagrams showing the detailed constitution of a glass substrate included in the exposure unit in the image forming apparatus according to the first embodiment of the invention.

FIG. 5 is a diagram showing a section of an organic electroluminescence element included in the exposure unit in the image forming apparatus according to the first embodiment of the invention and a section of structures around the organic electroluminescence element.

FIG. 6 is a diagram showing a top surface of the organic electroluminescence element included in the exposure unit in the image forming apparatus according to the first embodiment of the invention and a top surface of the structures around the organic electroluminescence element.

FIG. 7 is a diagram showing a top surface of the plural organic electroluminescence element included in the exposure unit in the image forming apparatus 1 according to the first embodiment of the invention and a top surface of the structures around the organic electroluminescence elements.

FIG. 8 is a block diagram showing the constitution of a processing circuit included in the exposure unit in the image forming apparatus according to the first embodiment of the invention.

FIG. 9 is a block diagram showing the constitution of a controller in the image forming apparatus according to the first embodiment of the invention.

FIG. 10 is an explanatory view showing contents of a light quantity correction data memory in the image forming apparatus according to the first embodiment of the invention.

FIG. 11 is a block diagram showing the constitution of an engine control part in the image forming apparatus according to the first embodiment of the invention.

FIG. 12 is a circuit diagram of the exposure unit in the image forming apparatus according to the first embodiment of the invention.

FIG. 13 is a diagram showing the constitution of an exposure unit in an image forming apparatus according to a second embodiment of the invention.

FIG. 14 is a block diagram showing the constitution of an engine control part in the image forming apparatus according to the second embodiment of the invention

FIG. 15 is a characteristic diagram showing one example of a relation between output current of a light receiving element formed of polysilicon and the temperature.

FIG. 16 is a sectional view showing the schematic constitution of the organic electroluminescence element used as a light source in the first embodiment.

FIG. 17 is a characteristic diagram showing an example of a relation between temperature and sensitivity of a photoconductor that is an image bearing body.

### DETAILED DESCRIPTION

Embodiments of the invention will be described below with reference to drawings.

### First Embodiment

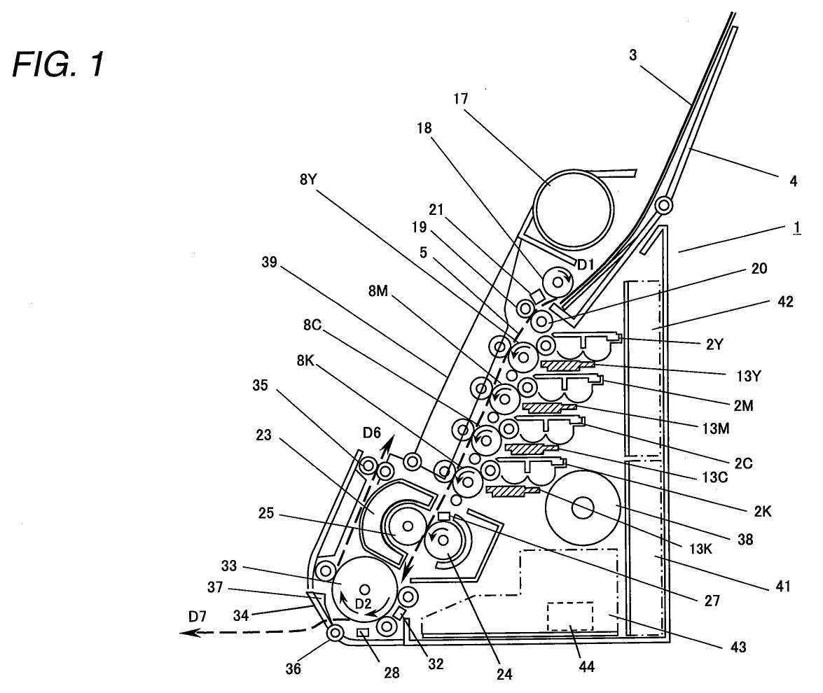

FIG. 1 is a constitutional view of an image forming apparatus according to a first embodiment of the invention. An image forming apparatus 1 in FIG. 1 includes a yellow development station 2Y, a magenta development station 2M, a cyan development station 2C, and a black development station 2K, which are arranged in tiers in the vertical direction; a toner bottle 17; exposure units 13Y, 13M, 13C and 13K which are arranged below each development station 2Y, 2M, 2C, 2K; a paper supply tray 4; a recording sheet transport path 5 which is a transport path of a recording sheet 3 supplied from the paper supply tray 4; a paper feed roller 18; a pair of a regist roller 19 and a pitch roller 20 which constitute a nip transport means located on an entrance side; a fuser 23 which constitutes a nip transport means located on an exit side; a recording sheet transporting drum 33; a face-down paper discharge part 34; a kick-out roller 35; and a paper exit tray 39. Further, the image forming apparatus 1 includes a drive source 38, a controller 41, an engine control part 42, and a power supply part 43. Further, the image forming apparatus 1 includes a recording sheet passage detecting sensor 21 arranged between the paper feed roller 18 and the nip transporting means on the entrance side, a recording sheet rear end detecting sensor 28 arranged below the recording sheet transporting drum 22, and a toner image detecting sensor 32 arranged on the lateral side of the recording sheet transporting drum 33.

The development stations 2Y to 2K form a toner image respectively by means of toners supplied from the toner bottle 17 for yellow, magenta, cyan and black. The toner bottles 17 store yellow, magenta, cyan and black toners, and supply the toner of each color to each development station 2Y to 2K. The toner supply is performed through a toner transport pipe (not shown) arranged between the toner bottle 17 and each development station 2Y to 2K.

The yellow development station 2Y includes a photoconductor 8Y, the magenta development station 2M includes a photoconductor 8M, the cyan development station 2C includes a photoconductor 8C, and the black development station 2K includes a photoconductor 8K. The photoconductors 8Y to 8K are exposed to the light by the exposure units 13Y to 13K, and an electrostatic latent image is formed on the surface of each photoconductor. Further, each development station 2Y to 2K includes members for realizing a development step in a series of electrophotographic process, such as a development sleeve a charger and the like which will be described later.

Though the development stations 2Y to 2K are different from one another in development color, they have the same constitution. Therefore, in order to simplify the following description, we will describe the development stations 2Y to 2K as the development station 2 without specifying the color, except the case where the development station must be particularly specified. Further, we will describe the corresponding photoconductors 8Y to 8K and exposure units 13Y to 13K as the photoconductor 8 and the exposure unit 13 similarly.

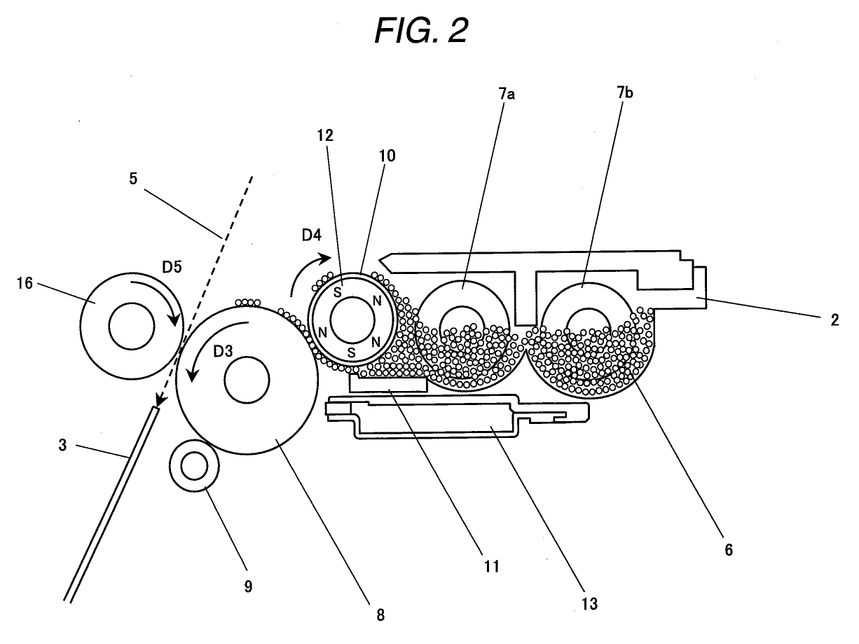

FIG. 2 shows the constitution around the development station 2 in the image forming apparatus 1 in FIG. 1.

The development station 2 in FIG. 2 includes agitating paddles 7a and 7b, a photoconductor 8, a charger 9, a development sleeve 10, and a layer thinning blade 11. In a container in which the agitating paddles 7a and 7b are housed, developer 6 that is a mixture of carrier and toner is filled. Below the development station 2, the exposure unit 13 is arranged; and in a position opposed to the photoconductor 8 with the recording sheet transport path 5 between, a transfer roller 16 is arranged.

The agitating paddles 7a and 7b agitate the developer 6, and the toner in the developer 6 is charged with the predetermined potential by friction with the carrier produced by rotation of the agitating paddles 7a and 7b. Further, the toner and the carrier go round in the container of the development station 2 thereby to be agitated and mixed sufficiently.

The photoconductor 8 is an image bearing body which bears an image formed by exposure by the exposure device 13, and a so-called organic photoconductor drum in which a charge generation layer and a charge transport layer (both layers are not shown) are laminated on a substrate such as an aluminum substrate and at least the charge transport layer is formed of organic matter. The photoconductor 8 rotates in a direction of D3 by a not-shown drive source. The charger 9 charges the surface of the photoconductor 8 with the predetermined potential.

The development sleeve 10 has a magnet roll 12 in which plural magnetic poles are formed, which rotates in a direction of D4 by a not-shown drive source. By this rotation and action of the magnetic poles in the magnet roll 12, the developer 6 is supplied onto the surface of the development sleeve 10. The layer thinning blade 11 regulates the layer thickness of the developer 6 supplied onto the surface of the development sleeve 10. The developer 6 on the surface of the development sleeve 10 develops an electrostatic latent image formed on the photoconductor 8 by the exposure unit 13 described later, and the developer 6 that has not been transferred onto the photoconductor 8 is recovered in the container of the development station 2.

The exposure unit 13 exposes the photoconductor 8 to the light, and has a light emitting element array (not shown in FIG. 2) in which organic electroluminescence elements as an exposure source are arranged in array with resolution of 600 dpi (dot per inch). This organic electroluminescence element which constitutes the light emission part that emits light for exposing the photoconductor 8 to the light is selectively turned on and off according to image data, whereby an electrostatic latent image of A4 size at most can be formed on the photoconductor 8 charged with the predetermined potential by the charger 9. Then, only the toner in the developer 6 supplied to the surface of the development sleeve 10 attaches to this electrostatic latent image portion, and the electrostatic latent image is made visible.

As described later in detail, in the exposure device 13, a light receiving element constituting a light quantity measuring part which measures the quantity of the light emitted from the organic electroluminescence element is formed in one-to-one relation with the organic electroluminescence element. A detection signal by the light receiving element is used in drive control of the organic electroluminescence element.

The transfer roller 16 is provided in a position where it is opposed to the photoconductor 8 with the recording sheet transport path 5 between, and rotates in a direction of D5 by a not-shown drive source. The predetermined transfer bias is applied to the transfer roller 16, and the transfer roller 16 transfers a toner image formed on the photoconductor 8 to a recording sheet 3 transported in the recording sheet transport path 5.

Turning to FIG. 1, we will continue the description.

The paper supply tray 4 is arranged above the development stations 2Y to 2K arranged in tiers in the vertical direction, in which the recording sheet 3 is housed. The recording sheet 3 supplied from the paper supply tray 4 is transported in the recording sheet transport path from the upside to the downside in the vertical direction.

The paper feed roller 18 controls a not-shown electromagnetic clutch thereby to rotate in a direction of F1, and feeds out the recording sheet 3 located on the paper supply tray 4 to the recording sheet transport path 5.

The regist roller 19 and pinch roller 20 pair constitutes the nip transporting means on the entrance side, and is provided in the recording sheet transport path 5 located between the paper feed roller 18 and a transfer part of the most upstream yellow development station 2Y The regist roller 19 and pinch roller 20 pair stops temporarily the recording sheet 3 transported by the feed roller 18, and transports the recording sheet 3 in the direction of the yellow development station 2Y at the predetermined timing. This temporary stop regulates the leading end of the recording sheet 3 in parallel to the axial direction of the regist roller 19 and pinch roller 20 pair, thereby to prevent skew of the recording sheet 3.

The recording sheet passage detecting sensor 21 detects the passage of the recording sheet 3. The recording sheet passage detecting sensor 21 is composed of a reflection-type sensor (photo reflector), and detects the leading end and the rear end of the recording sheet 3 by the presence and absence of the reflection light.

The feed mechanism of the recording sheet 3 is constructed as described above. Therefore, when the power transmission is controlled by a not-shown electromagnetic clutch and the rotation of the regist roller 19 is started, the recording sheet 3 that has been stopped temporarily is transported along the recording sheet transport path 5 in the direction of the yellow development station 2Y Further, with the timing of rotation start of the regist roller 19 as a starting point, writing timing of electrostatic latent images by the exposure units 13Y to 13K arranged respectively near the development stations 2Y to 2K, ON/OFF of development bias, and ON/OFF of transfer bias are independently controlled respectively.

The fuser 23 which constitutes the nip transporting means on the exit side is provided in the recording sheet transport path 5 which is located on the downstream side of the most downstream black development station 2K. The fuser 23 includes a heat roller 24, a pressure roller 25, and a temperature sensor 27.

The temperature sensor 27 is used to detect the temperature of the heat roller 24. The temperature sensor 27, which has metal oxide as main material, is a ceramics semiconductor obtained by sintering at a high temperature, and measures the temperature of a contact object by applying the change in load resistance according to the temperature. The output of the temperature sensor 27 is inputted to an engine control part 42 described later, and the engine control part 42 controls the power to be supplied to a heat source (not shown) included in the heat roller 24 on the basis of the output of the temperature sensor 27 so that the surface temperature of the heat roller 24 becomes about 170° C.

When the recording sheet 3 on which the toner image has been formed passes through this fuser 23, the toner image on the recording sheet 3 is heated and pressurized by the heat roller 24 of which the temperature has been controlled and the pressure roller 25, and fused on the recording sheet 3.

The recording sheet rear end detecting sensor 28 is used to monitor the discharge condition of the recording sheet 3. The toner image detecting sensor 32 is used to detect a position and a density of a toner image. The toner image detecting sensor 32 is a reflection-type sensor unit using plural light emitting elements which are different in emission spectrum (visible light) and a single light receiving element, which detects the image density by using that the absorption spectrum is different between the base surface of the recording sheet 3 and the image forming portion thereof according to the image color. Further, the toner image detecting sensor 32 can detect not only the image density but also the image forming position. Therefore, in the image forming-apparatus 1 in FIG. 1, the toner image detecting sensors 32 are provided in two places in the width direction of the image forming apparatus 1, and control the image forming timing on the basis of the detection position of an out-of-image registration amount detection pattern formed on the recording sheet 3.

The recording sheet transporting drum 33 is used to transport the recording sheet 3 on which the image has been fused. The recording sheet transporting drum 33 is a metallic roller of which the surface is coated with rubber having the thickness of about 200 μm. The recording sheet 3 on which the image has been fused is transported along the recording sheet transporting drum 33 in a direction of D2. At this time, the recording sheet 3 is cooled by the recording sheet transporting drum 33, and curved and transported so that the image forming surface faces on the outside. Hereby, it is possible to reduce greatly a curl produced in case that an image of high density is formed on the entire surface of the recording sheet. Thereafter, the recording sheet 3 is transported by the kick-out roller 35 in a direction of D6, and discharged onto the exit tray 39.

The face-down paper discharge part 34 is constructed rotatably around a support member 36, and when the face-down paper discharge part 34 is put in an open state, the recording sheet 3 is discharged in a direction of D7. This face-down paper discharge part 34 has at its back surface a rib 37 formed along the transport path so as to guide the transportation of the recording sheet 3 together with the recording sheet transporting drum 33 in the close state.

The drive source 38 is used to drive each drive part included in the image forming apparatus 1, and adopts a stepping motor in the image forming apparatus in FIG. 1. As the drive parts which are driven by the drive source 38, there are the paper feed roller 18, the regist roller 19, the pinch roller 20, drive parts around each development station 2Y to 2K including each photoconductor 8Y to 8K and the transfer roller 16 (refer to FIG. 2), the fuser 23, the recording sheet transporting drum 33, and the kick-out roller 35.

The controller 41 receives image data from an outside computer (not shown) through an outside network and expands the reception data thereby to generate binary image data that is printable. Further, as described later in detail, a controller CPU (not shown in FIG. 1) mounted on the controller 41 accepts the measurement data of the emitted light quantity of the organic electroluminescence element which has been measured by the light receiving element constituting the light quantity measuring part provided for each exposure unit 13Y to 13K (The measurement data accepted by the controller CPU, which will be described later, is corrected by a characteristic difference correcting part.), and functions as a light quantity control part of the organic electroluminescence element. Namely, the controller CPU functions as a light quantity correcting part which generates light quantity correction data, and also as a light quantity setting part which sets the light quantity of the organic electroluminescence element on the basis of the light quantity correction data. The control of light quantity will be described later in detail.

The engine control part 42 performs the whole control of the image forming apparatus 1. As the controls performed by the engine control part 42, there are control of hardware and mechanism in the image forming apparatus 1 for the purpose of forming a color image on the recording sheet 3 on the basis of the image data and the light quantity correction data which have been transferred from the controller 41, and temperature control of the heat roller 24 in the fuser 23.

The power supply part 43 supplies power to each part of the image forming apparatus 1. Specifically, the power supply part 43 supplies the power of the predetermined voltage to the exposure units 13Y to 13K, the drive source 38, the controller 41, and the engine control part 42, and supplies the power to the heat roller 24 in the fuser 23. Further, a so-called power supply system of high voltage such as charge potential for charging the surface of the photoconductor 8, development bias applied to the development sleeve (refer to FIG. 2), and transfer bias applied to the transfer roller 16 is also included in this power supply part 43. Further, the engine control part 42, by controlling the power supply part 43, adjusts not only ON/OFF of the high-voltage power supply but also an output voltage value and an output current value.

Further, the power supply part 43 includes a power supply monitoring part 44 which can monitor at least the power supply voltage supplied to the engine control part 42 and the output voltage of the power supply part 43. A monitor signal from the power supply monitoring part 44 is inputted to the engine control part 42, and utilized to detect lowering of the power supply voltage produced in power switch off or power breakdown, and particularly abnormal output of the high-voltage power supply.

The operation of the thus constructed image forming apparatus 1 will be described with reference to FIGS. 1 and 2. The constitution and the general operation of the image forming apparatus 1, referring mainly to FIG. 1, will be described with color distinction like the development stations 2Y to 2K, the photoconductors 8Y to 8K, and the exposure units 13Y to 13K. Further, in the following description about monochrome in the exposure and development steps, referring mainly to FIG. 2, it will be described without color distinction like the development station 2, the photoconductor 8, and the exposure unit 13 for the purpose of simplification of the description.

Firstly, the operation of initialization when the power is inputted in the image forming apparatus 1 will be described. When the power is inputted, an engine control CPU (not shown in FIG. 1) mounted on the engine control part 42 executes error check of an electric resource constituting the image forming apparatus 1, that is, error check of a writable and readable register or memory. Upon completion of this error check, the engine control CPU (not shown in FIG. 1) starts rotation of the drive source 38. As described above, by the drive source 38, the paper feed roller 18, the regist roller 19, the pinch roller 20, the parts around each development station 2Y to 2K including each photoconductor 8Y to 8K and the transfer roller 16 (refer to FIG. 2), the fuser 23, the recording sheet transporting drum 33, and the kick-out roller 35 are driven. However, immediately after the power has been input, an electromagnetic clutch (not shown) for transmitting the drive power to the paper feed roller 18 and the regist roller 19 which are concerned with the transportation of the recording sheet 3 is set to OFF, so that the feed roller 18 and the regist roller 19 are controlled so as to disenable the transportation of the recording sheet 3.

Referring next to FIG. 2, the operations of the surrounding parts of the development station 2 will be described. With the rotation of the drive source 38 (refer to FIG. 1), the agitating paddles 7a, 7b of the development station 2 and the development sleeve 10 also start rotating. Hereby, the developer 6 composed of the toner and carrier, which is filled in the container of the development station 2, goes round in the container of the development station 2, and the toner is charged negatively by the mutual friction of the toner and the carrier.

The engine control CPU (not shown in FIG. 1), after the predetermined time has passed since the drive source 38 (refer to FIG. 1) started rotating, controls the power supply part 43 (refer to FIG. 1) thereby to turn on the charger 9. By the charger 9, the surface of the photoconductor 8 is charged with, for example, −700V potential. The photoconductor 8 is rotating in the direction of D3, and the engine control CPU (not shown in FIG. 1), after the charged area of the photoconductor 8 has reached at the development area, that is, in a position where the photoconductor 8 and the development sleeve 10 come closest to each other, controls the power supply part 43 (refer to FIG. 1) and applies the development bias of, for example, −400V to the development sleeve 10. Since the surface potential of the photoconductor 8 is −700V at this time and the development bias applied to the development sleeve 10 is −400V, an electric line of force goes from the development sleeve 10 to the photoconductor 8. At this time, since the Coulomb force which acts on the toner charged negatively goes from the photoconductor 8 to the development sleeve 10, the toner never attaches to the photoconductor 8.

As described before, the power supply part 43 (refer to FIG. 1) has the function of monitoring the abnormal output (for example, leak) of the high-voltage power supply, and the engine control CPU (not shown) can check the abnormality when the power supply part 43 applies the high voltage to the charger 9 and the development sleeve 10.

At the last of a series of these operations for initialization, the engine CPU (not shown in FIG. 1) executes the light quantity correction of the exposure unit 13. Namely, the engine control CPU (not shown in FIG. 1) mounted on the engine control part 42 (refer to FIG. 1) outputs a creation request of dummy image data for light quantity correction to the controller 41 (refer to FIG. 1). On the basis of this creation request, the controller 41 (refer to FIG. 1) creates the dummy image data for light quantity correction. On the basis of the created dummy image data, ON of the organic electroluminescence element constituting the exposure unit 13 is controlled in the initialization time. In the image forming apparatus in the first embodiment, at this time, the light receiving element (not shown in FIG. 1) provided for the exposure unit 13 measures the emitted light quantity of each organic electroluminescence element. On the basis of the detection result of this emitted light quantity, the light receiving element corrects the light quantity so that the light emission quantities of the respective organic electroluminescence elements become nearly equal.

The measurement of the emitted light quantity of the organic electroluminescence element is executed in a state where the photoconductor 8 of the image forming apparatus 1 and the unit relating to the image formation such as the development stations 2Y to 2K are driving. This is because: in case that the emitted light quantity is measured in a state where the rotation of the photoconductor 8 is stopped, the same portion on the photoconductor 8 is continuously exposed to the light and put in a so-called light exposure state, whereby the characteristic of the photoconductor 8 deteriorates partially Accordingly, the measurement of the emitted light quantity must be performed at least in a state where the rotation of the photoconductor 8 is driven and the photoconductor 8 is charged by the charger 9 in order to prevent the toner attachment onto the photoconductor 8. However, by contriving to prevent the same portion on the photoconductor 8 from being continuously exposed to the light by the light quantity measurement, for example, by changing, when the operation of the image forming apparatus 1 is stopped, the stop timing appropriately and preventing the same portion on the photoconductor 8 from being exposed to the light, it is possible to measure the emitted light quantity of the organic electroluminescence element in the state where the photoconductor 8 is stopped.

Next, referring successively to FIGS. 1 and 2, the image forming operation of the image forming apparatus 1 will be described. When the image data is transferred to the controller 41 from the outside, the controller 41 expands the image data in an image memory (not shown in FIG. 1) as, for example, binary image data that is printable. Upon completion of the expansion of image data, the controller CPU (not shown in FIG. 1) mounted on the controller 41 makes a starting request for the engine control part 42. This starting request is received by the engine control CPU (not shown in FIG. 1) mounted on the engine control part 42, and the engine control CPU (not shown in FIG. 1) which has received the starting request rotates immediately the drive source 38 and starts the preparation for image formation.

This step is similar to the case of the operation of initialization that has been already described except the error check on the electric resource, and the engine control CPU (not shown in FIG. 1) can measure the emitted light quantity of the organic electroluminescence element in accordance with the above-mentioned sequence also at this time. The light quantity measuring time of the organic electroluminescence element by the light receiving element in the image forming apparatus 1 in the first embodiment is set to about 20 ms, which will be described later. Therefore, in case that the emitted light quantities of all the organic electroluminescence elements mounted on the exposure unit 13 are measured in a period divided into, for example, 16, the measurement is completed in 20 ms×16=320 ms.

Upon completion of the preparation of the image formation through the above-mentioned step, the engine control CPU (not shown) mounted on the engine control part 42 controls the electromagnetic clutch (not shown) thereby to rotate the paper feed roller 18 and start transporting the recording sheet 3. The feed roller 18 is a semicircular roller that lacks a part of the periphery, which transports the recording sheet 3 in the direction of the regist roller 19, and stops, after rotating one time, its rotation. The engine control CPU (not shown), when the leading end of the transported recording sheet 3 is detected by the recording sheet passage sensor 21, controls the electromagnetic clutch (not shown) with the predetermined delay period and rotates the regist roller 19. With the rotation of this regist roller, the recording sheet 3 is supplied to the recording sheet transport path.

The engine control CPU (not shown in FIG. 1), with the timing of rotation start of the regist roller 19 as a starting point, controls independently writing timings of electrostatic latent images by the respective exposure units 13Y to 13K. Since the writing timing of the electrostatic latent image affects directly out-of-color registration in the image forming apparatus 1, the engine control CPU (not shown in FIG. 1) never generates directly the writing timing. Specifically, the engine control CPU (not shown in FIG. 1) previously sets, in a timer that is a not-shown hardware, the writing timing of the electrostatic latent image by each exposure unit 13, and starts simultaneously the operations of the timers corresponding to the respective exposure units 13Y to 13K with the rotation of the above regist roller 19 as a starting point. Each timer, when the predetermined time has passed, outputs an image data transfer request to the controller 41.

The controller CPU (not shown in FIG. 1) of the controller 41 which has received the image data transfer request transfers the binary image data to each exposure unit 13Y to 13K independently in synchronization with timing signals (clock signal and line synchronization signal) generated by a timing generation part (not shown in FIG. 1) of the controller 41. The binary image data are thus transferred to the exposure units 13Y to 13K, ON/OFF of the organic electroluminescence element which constitutes the exposure unit 13Y to 13K is controlled, and the photoconductor 8Y to 8K corresponding to each color is exposed to the light.

The latent image formed by the exposure is made visible by the toner included in the developer 6 supplied onto the development sleeve 10 as shown in FIG. 2. Toner images of the respective colors which have been made visible are transferred in order onto the recording sheet 3 transported in the recording sheet transport path 5. The recording sheet 3 on which the transfer of the toner images of four colors has been completed is transported to the fuser 23, and transported, being held between the heat roller 24 and the pressure roller 25 which constitute the fuser 23. Accordingly, the transferred toner images are fixed to the recording sheet 3 by heat of the heat roller 24 and pressure of the pressure roller.

In case that the image to be formed extends for plural pages, the engine control CPU (not shown in FIG. 1), after the rear end of the recording sheet 3 of the first page has been detected by the recording sheet passage detecting sensor 21, stops the rotation of the regist roller 19 once, rotates the feed roller 18 after the predetermined time has passed thereby to start the transportation of the next recording sheet 3, and starts the rotation of the regist roller 19 again after the predetermined time has further passed thereby to supply the recording sheet 3 of the next page to the recording sheet transport path 5. By thus controlling the timing of rotation ON/OFF of the regist roller 19, in case that the images are formed on the plural pages, the time interval between the recording sheets 3 can be set. The time (hereinafter referred to as a paper interval time) between these recording sheets 3 (hereinafter referred to as a paper interval period), which is different also in the specification of the image forming apparatus 1, is set generally to about 500 ms. In the paper interval period, the normal image forming operation (that is, the exposure operation for the photoconductor 8 by the exposure unit on the basis of the image data supplied from the outside of the image forming apparatus 1) is not performed.

In the image forming apparatus 1 in the first embodiment, the emitted light quantity of the above-mentioned organic electroluminescence element is measured in this paper interval period. Hereby, the emitted light quantity of the organic electroluminescence element can be always controlled uniformly. Further, since the measurement of the emitted light quantity of the organic electroluminescence element can be performed in a short time of 320 ms as described above, the emitted light quantity can be measured at the arbitrary timing. Further, in case that the plural pages are printed, it is not necessary to measure the emitted light quantity in all the paper interval periods. For example, the when of measuring the inner temperature of the image forming apparatus 1 by a not-shown temperature detecting means and detecting the specified temperature difference from the initial temperature, or the when of reaching the predetermined printed number may be taken as the measurement timing of the emitted light quantity.

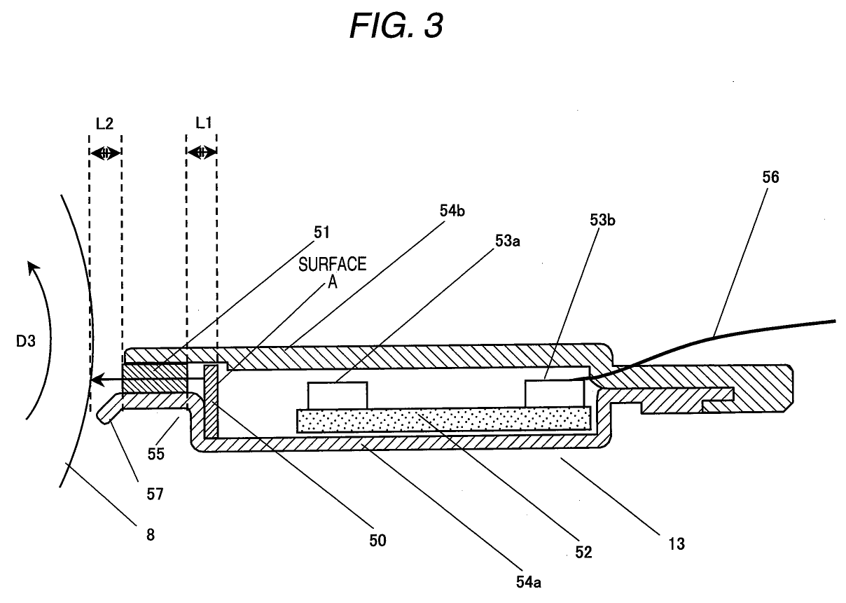

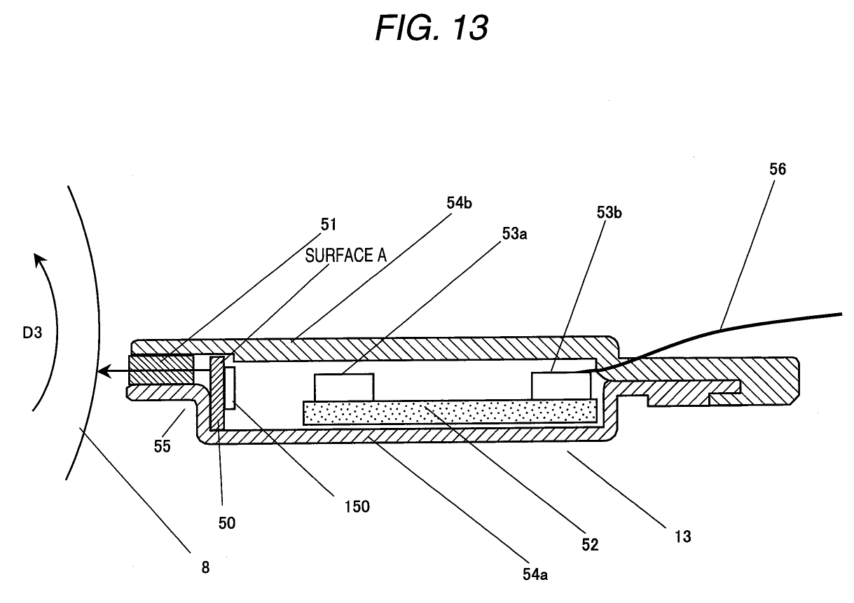

FIG. 3 shows the constitution of the exposure unit 13 in the image forming apparatus 1 according to the first embodiment of the invention. The exposure unit 13 in FIG. 13 includes a glass substrate 50, a lens array 51, a relay board 52, a connector A 53a, connector B 53b, a housing A 54a, and a housing B 54b.

The glass substrate 50 is a colorless and clear substrate which forms the organic electroluminescence element as the light emitting element which will be described later, and a thin-film transistor which constitutes a control circuit and a drive circuit, and this is formed of, for example, B boro-silicate glass. The B boro-silicate glass is advantage in cost. However, in case that heat radiation of the organic electroluminescence element and the thin-film transistor must be efficiently performed, glass containing thermal conductivity additive factors such as MgO, Al₂O₃, CaO, and ZnO, or vitreous silica may be used. On a surface A of the glass substrate 50, the organic electroluminescence element and the light receiving element (not shown in FIG. 3) are formed in the direction perpendicular to the drawing (in the main scanning direction) at 600 dpi resolution.

The lens array 51 is formed by arranging bar lens (not shown) formed of plastic or glass in line, and is used in order to lead the emission light from the organic electroluminescence element formed on the surface A of the glass substrate 50 as an erect and equally-magnified image onto the surface of the photoconductor 8. The positional relation among the glass substrate 50, the lens array 51, and the photoconductor 8 is adjusted so that one focus of the lens array 51 is on the surface A of the glass substrate 50 and the other focus thereof is on the surface of the photoconductor 8. Namely, the positional relation among them is set to L1=L2, in which L1 is a distance from the surface A to the surface of the lens array 51 which is close to the surface A, and L2 is a distance from the other surface of the lens array 51 to the surface of the photoconductor 8.

The relay board 52 relays the image data and the light quantity correction data and other control signals, which are supplied from the outside, and is formed, for example, by forming an electronic circuit on a glass epoxy substrate. On the relay board 52, at least the connector A53a and the connector B53b are mounted. The image data, the light quantity correction data, and other control signals are supplied from the outside by a cable 56 such as a flexible flat cable, relayed once through the connector B53b, and passed to the glass substrate 50.

It is difficult to mount the connector directly on the surface of the glass substrate 50 considering strength of joint and reliability in various environments. Therefore, in the exposure unit 13 in FIG. 3, as connection means of the connector A53a of the relay board 52 with the glass substrate 50, FPC (Flexible Print Circuit) is adopted (not shown in FIG. 3). Regarding joint of the glass substrate 50 and the FPC, by means of, for example, ACF (Anisotropic Conductive Film), the FPC is directly connected to an ITO (Indium-Tin-Oxide) electrode previously formed on the glass substrate 50.

Generally, the connection by the ACF has frequently a problem in strength of joint. However, by thus providing the connector B53b for connecting the exposure unit 13 on the relay board 52 by the user, an interface to which the user directly accesses can secure the sufficient strength.

The housing A54a is formed, for example, by bending a metal plate. On the side of the housing A54a which is opposed to the photoconductor 8, an L-shaped portion 55 is formed, and the glass substrate 50 and the lens array 51 are arranged along the L-shaped portion 55. In case that the forming accuracy of the L-shaped portion 55 is secured by the structure in which the end surface on the photoconductor 8 side of the housing A54a is matched with the end surface of the lens array 51 on the same surface and one end of the glass substrate 50 is supported by the housing A54a, it is possible to make accurately the positional relation formed by the glass substrate 50 and the lens array 51. Since the housing A54a thus requires the dimensional accuracy, it is desirable that the housing A54a is formed of metal. Further, by the making the housing A54a of metal, influences of noise on the electronic parts such as a control circuit formed on the glass substrate 50 and an IC chip mounted on the surface of the glass substrate 50 can be suppressed.

Further, the housing A54a has, at the portion opposed to the photoconductor 8, a protrusion part 57 which protrudes more to the photoconductor 8 side than the lens array 51. Though the protrusion part 57 comes into non-contact with the photoconductor 8, it is arranged close to the photoconductor 8 to such a degree, in consideration of mechanical tolerances such as distortion and axial deflection of the photoconductor 8, that the charge of the photoconductor 8 is not removed. The protrusion part 57 transmits the atmospheric temperature near the photoconductor 8 to the glass substrate 50 arranged in the exposure unit 13, and has the action of making the temperature distribution in the arrangement direction of the organic electroluminescence elements and the light receiving elements provided on the glass substrate 50 nearly the same as the temperature distribution in the direction of the rotational shaft of the photoconductor 8 (that is, in the main scanning direction).

The housing B54b is obtained by molding resin. Near the connector B53b of the housing B54b, a notch portion (not shown) is provided, and the user can access to the connector B53b from this notch portion. Through the cable 56 connected to the connector B53b, from the before-mentioned controller 41 (refer to FIG. 1), the image data, the light quantity correction data, the control signals such as the clock signal and the line synchronization signal, the drive power for the control circuit, and the drive power for the organic electroluminescence element which is the light emitting element are supplied to the exposure unit 13. As shown in FIG. 3, in the space formed by the housing A54a and the housing B54b, the relay board 52 is arranged.

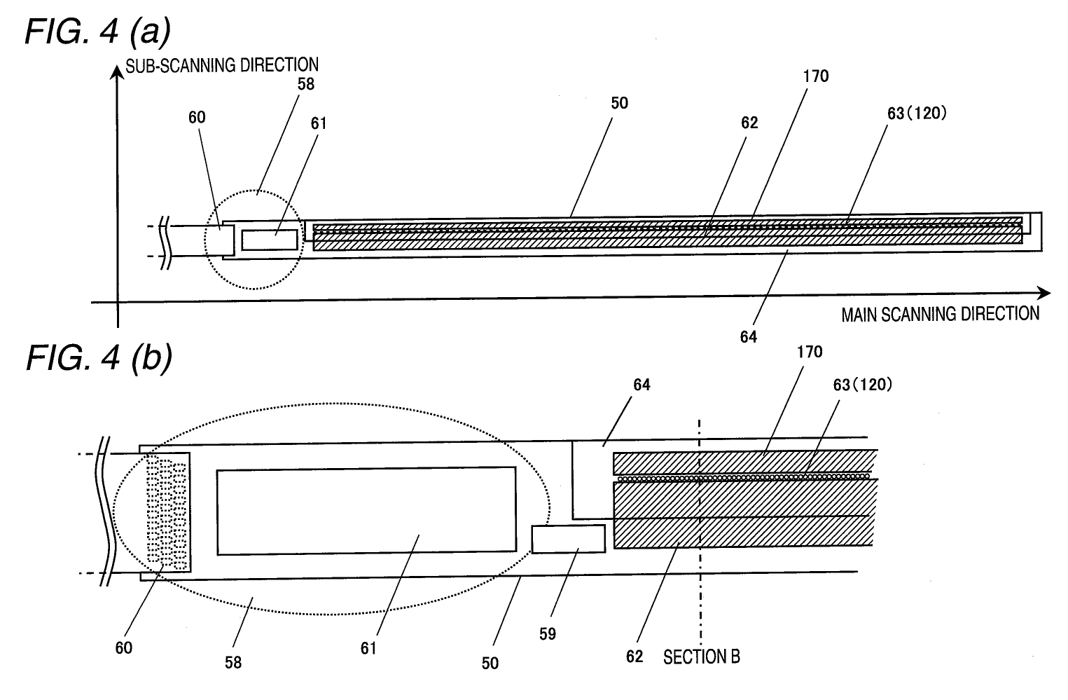

FIGS. 4(a) and 4(b) show the detailed constitution of the glass substrate 50 included in the exposure unit 13 in the image forming apparatus 1 according to the first embodiment of the invention. FIG. 4(a) is a top view of the glass substrate 50 and FIG. 4(b) is a main portion enlarged view of the glass substrate 50. Referring to FIGS. 4 and 3, the constitution of the glass substrate 50 will be described below in detail.

The glass substrate 50 is a rectangular substrate having the thickness of about 0.7 mm, and at least a long side and a short side. In its long side direction (main scanning direction), the plural organic electroluminescence elements 63 which are the exposure sources for the photoconductor 8 (refer to FIG. 2) are formed at 600 dpi (at 42.3 μm pitches) in line. In the normal direction on the glass substrate 50 to these organic electroluminescence elements 63, the light receiving elements 120 are formed. Namely, the organic electroluminescence element 63 and the light receiving element 120 have the laminated structure as a whole (the detailed structure will be described later). In the long side direction of the glass substrate 50 in FIG. 4, there are arranged the organic electroluminescence elements 63 and the light receiving elements 120 which are have the number necessary to the exposure of at least A4 size (210 mm) (the number of both elements is 5120 respectively). The length in the long side direction of the glass substrate 50 is 250 mm, including the arrangement space of a drive control part 58 described later. Though the glass substrate 50 is described as the rectangular shape in FIG. 4 in order to simplify the description, such a modified shape that a notch for positioning when the glass substrate 50 is attached to the housing A54a is provided partially in the glass substrate 50 may be given. Further, although the organic electroluminescence elements 63 formed on the glass substrate 50 are arranged in a line, they may be arranged in plural lines, or in plural lines and in a zigzag patter.

On both sides of the organic electroluminescence element 63 and the light receiving element 120 on the glass substrate 50, a first TFT (Thin Film Transistor) circuit 62 and a second TFT circuit 170 are provided, which control ON/OFF of each organic electroluminescence element 63, and the detection of emitted light quantity independently. Namely, each organic electroluminescence element 63 is active matrix-driven by the TFT circuit (first TFT circuit) of which the details will be described later. The organic electroluminescence element 63 and the first TFT circuit 62 constitute a light emission part 600 (described later in detail) which emits light for exposing the photoconductor 8 to the light. Further, the light receiving element 120 and the second TFT circuit 170, together with a processing circuit 59, measures the emitted light quantity of the light emission part 600 and constitute a light quantity measuring part 700 (described later in detail) which outputs a light quantity measuring signal (both of the light emission part 600 and the light quantity measuring part 700 are formed on the glass substrate 50).

The whole of the organic electroluminescence elements 63 and the second TFT circuit 170, and a part of the first TFT circuit 62 are sealed by a seal glass 64. When the organic electroluminescence element 63 receives an influence of water, shrinking per hour of the luminous area or a non-light emission portion (dark spot) in the luminous area is produced, whereby the light emission characteristic of the organic electroluminescence element deteriorates greatly. Therefore, the seal glass 64 is used to shield the organic electroluminescence element from the water. The seal glass 64 in FIG. 4 is stuck on the glass plate 50 by a sticky seal method of sticking the seal glass through an adhesive. The organic electroluminescence element 63 in FIG. 4 adopts polymer material as material of a light emission layer forming the luminous area. Since the polymer material is not clear in glass transition temperature, and has little characteristic deterioration by crystallization even under the high temperature, thermosetting resin which is better in gas barrier property than UV—curable resin can be adopted in sealing.

At one end of the glass substrate 50, a drive control part 58 is provided, and further an FPC (Flexible Print Circuit) 60 is connected thereto as interface means. The drive control part 58 accepts the binary image data, the light quantity correction data, and the control signals such as the clock signal and the line synchronization signal, which are supplied from the outside of the glass substrate 50, and controls the drive of the organic electroluminescence element 63 on the basis of these signals. The drive control part 58 includes the interface means which accepts these signals from the outside of the glass substrate 50 and an IC chip (source driver 61) which controls the drive of the organic electroluminescence element 63 on the basis of the control signals accepted through the interface means.

The FPC 60 connects the connector A53a of the relay board 52 and the glass substrate 50, and is connected directly to a not-shown circuit pattern provided for the glass substrate 50 without a connector. As described before, the binary image data, the light quantity correction data, the control signals such as the clock signal and the line synchronization signal, the drive power for the control circuit, and the control power for the organic electroluminescence element 63 that is the light emitting element, which have been supplied from the outside to the exposure unit 13, pass through the relay board 52 shown in FIG. 3 once, and thereafter are supplied through the FPC 60 to the glass substrate 50.

A source driver 61 is an IC chip, which controls the drive of the organic electroluminescence element 63 and is flip-chip mounted on the glass substrate 50. In consideration of the surface mount on the glass surface, the source driver 61 adopts a bare chip product. To the source driver 61, the power, the control relating signals such as the clock signal and the line synchronization signal, and the light quantity correction data of 8 bit are supplied from the outside of the exposure unit 13 through the FPC 60. The source driver 61 functions as drive current setting means for the organic electroluminescence element 63. More specifically, the source driver 61, on the basis of the light quantity correction data generated by the controller CPU (not shown in FIG. 4) which functions as the light quantity correcting part and the light quantity setting part of the organic electroluminescence element 63 and is mounted on the controller 41 (refer to FIG. 1), sets the drive current for driving the respective organic electroluminescence elements 63. The operation of the source driver 61 on the basis of the light quantity correction data will be described later in detail.

On the glass substrate 50, the joint portion of the FPC 60 and the source driver 61 are connected to each other through an ITO (Indium-Tin-Oxide) circuit pattern (not shown) in which a metal layer is formed on the surface; and to the source driver 61 functioning as the drive current setting means, the light quantity correction data, and the control signals such as the clock signal and the line synchronization signal are inputted through FPC 60. As described above, the FPC 60 as the interface means and the source driver 61 as the drive parameter setting means constitute the drive control part 58.

The first TFT circuit 62 formed on the glass substrate 50 includes a shift register, a data latch part, a gate controller (not shown in FIG. 4) which is a logic circuit that controls ON/OFF timing of the organic electroluminescence element 63, and a drive circuit which supplies the drive current to each organic electroluminescence element 63 (not shown in FIG. 4. Hereinafter, referred to as a pixel circuit.). One pixel circuit is provided for each organic electroluminescence element 63, and the pixel circuits are provided in parallel to the light emitting element array formed by the organic electroluminescence elements 63. A drive current value for driving each organic electroluminescence element 63 is set in this pixel circuit by the source driver 61 which is the drive current setting means.

To the gate controller (not shown in FIG. 4) constituting the first TFT circuit 62, the power, the control signals such as the clock signal and the line synchronization signal, and the binary image data are supplied from the outside of the exposure unit 13 through the FPC 60, and the gate controller (not shown in FIG. 4) controls the ON/OFF timing of each light emitting element on the basis of these power and signals. The operations of the gate controller and the pixel circuit (both are not shown in FIG. 4) will be described later with reference to the drawing.

The second TFT circuit 170 formed on the glass substrate 50 is basically a switching circuit set. The second TFT circuit 170 constitutes a selection circuit for the 5120 light receiving elements 120 formed on the glass substrate 50, and leads the output of the selected organic electroluminescence element 120 to the processing circuit 59 described later. The organic electroluminescence element 63 which becomes an object of the light quantity measurement is limited to the turned-on element 63. Therefore, a lot of power and control signals supplied to the first TFT circuit 62 can be applied to the second TFT circuit 170. Hereby, it is possible to downscale the interface of the exposure unit 13. The output of the light receiving element 120 selected by the second TFT circuit 170 is inputted to the processing circuit 59 by not-shown wiring.

The processing circuit 59 is an analog/digital mixed IC chip, which converts at least the output of the light receiving element 120 into digital data and outputs the converted data. In this time, the processing circuit 59, after voltage-converting the photocurrent generated by the light receiving element 120, level-converts the voltage-converted output in a level converter (described later in detail), and further converts the level-converted output into digital data to output its digital data. The level converter, as described later, is used to correct the light quantity measurement data to be inputted to the controller 41. The correction of the temperature characteristic difference is performed by reducing a difference between a changing rate of density of the image formed by the photoconductor 8 for the temperature of the photoconductor 8, and a changing rate of the light quantity measurement data for the temperature. The processing circuit 59, together with the light receiving element 120 and the second TFT circuit 170, constitutes a light quantity measuring part 700 (described later in detail) which measures the emitted light quantity of the light emission part 60 and outputs a light quantity measuring signal. The processing circuit 59 has a function of a correction part (characteristic difference correcting part) which reduces a difference between the temperature characteristic of the light quantity measuring part 700 and the temperature characteristic of the photoconductor 8. The function of the characteristic difference correcting part may be omitted. The processing circuit 59 will be described later in detail. The positive correction of the temperature characteristic difference is not necessarily indispensable. For example, also by selecting appropriately the materials which form the light quantity measuring part 700 and the photoconductor 8, the correction of the temperature characteristic difference is achieved.

The digital data (hereinafter referred to as light quantity measuring data) from the processing circuit 59 is outputted through the FPC 60, the relay board 52, and the cable 56 (for all of them, refer to FIG. 3) to the outside of the exposure unit 13. As described later in detail, the light quantity measuring data is received by the controller CPU (not shown in FIG. 1) mounted on the controller 41 (refer to FIG. 1), and utilized in generation processing of the 8-bit light quantity correction data described later.

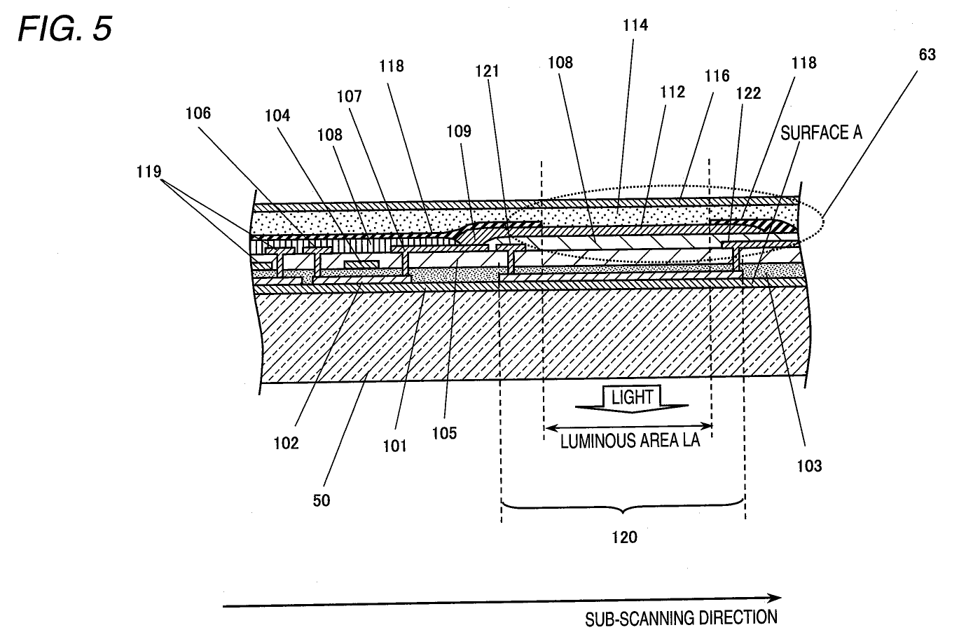

FIG. 5 shows a section of the organic electroluminescence element 63 included in the exposure unit 13 in the image forming apparatus 1 according to the first embodiment of the invention, and a section of structures around the organic electroluminescence element 63. FIG. 5 is a sectional view taken along a line B in FIG. 4. The constitution and operation of the organic electroluminescence element 63 will be described below in detail with reference to FIG. 5.

On the surface A (surface A in FIG. 2) of the glass substrate 50, a base coat layer 101 is formed. The base coat layer 101 is formed by laminating, for example, SiN and SiO₂. In a portion corresponding to the organic electroluminescence element 63 on the base coat layer 101, the light receiving element 120 is formed, and further, a protection layer 108, an anode 112, a light emission layer 114, and a cathode 116 are laminated on the light receiving element 120 through a gate insulation film 103 and an intermediate layer 105. A first electrode 121 and a second electrode of the light receiving element are formed between the intermediate layer 105 and the protection layer 108.

On the lateral side of the area corresponding to the organic electroluminescence element 63 on the base coat layer 101, the TFT 102 is provided, and a gate electrode is formed on the TFT 102 through the gate insulation layer 103. Further, a source electrode 106 and a drain electrode 107 are formed through the intermediate layer 105, and the protection layer 108, a pixel regulating part 118, the light emission layer 114, and the cathode 116 are laminated. On the lateral side of the TFT 102, a wiring pattern 119 is formed.

The light receiving element 120 constitutes the light quantity measuring part, which is formed of, for example, polysilicon. The light generated by the light emission layer 114 constituting the organic electroluminescence element 63 passes through the light receiving element 120 and the glass substrate 50 and is outputted to the outside (so-called bottom emission structure). Therefore, a small quantity of light absorption by the light receiving element 120 is desirable. In view of this, it is not preferable that noncrystal silicon which exhibits color is adopted, and it is desirable that the light receiving element 120 is formed of polysilicon which is high in light transmittance. In case that a so-called top emission structure in which light is emitted on the opposite side to the glass substrate 50 is adopted, it is desirable that the light receiving element 120 is rather formed of noncrystal silicon (amorphous silicon) which can generate a larger quantity of photocurrent. The light receiving element first electrode 121 is connected to the GND and the light receiving element second electrode 122 is connected to the second TFT circuit 170 (refer to FIG. 4).

The TFT 102 is formed of polysilicon. In the embodiment, although polysilicon is used for the TFT 102, noncrystal silicon (amorphous silicon) may be used. Though noncrystal silicon is more disadvantageous than polysilicon in design rule or drive frequency, it has the manufacturing process which is low in cost, so that it has a merit in cost. Further, in case that a part is formed of polysilicon and the other is formed of noncrystal silicon in a process of forming the TFT, the manufacturing process is complicated thereby to require high cost. Therefore, it is good that the above-mentioned light receiving element 120 and the TFT 102 are formed of the same material (polysilicon in the embodiment).

The TFT 102 and the gate electrode 104 formed of metal such as Mo are spaced and insulated by the gate insulation layer 103. The gate insulation layer 103 is formed of, for example, SiO₂. The intermediate layer 105 is formed by laminating, for example, SiO₂ and SiN. The intermediate layer 105 covers the gate electrode 104, and supports the source electrode 106 and the drain electrode 107 which are formed of metal such as Al along the surface of this intermediate layer 105. The source electrode 106 and the drain electrode 107 are connected through the intermediate layer 105 and a contact hole provided in the gate insulation layer 103 to the TFT 102. The predetermined potential is applied to the gate electrode 104 in a state where the predetermined potential difference is given between the source electrode 106 and the drain electrode 107, whereby the TFT 102 operates as a switching transistor.

The protection layer 108 is formed of, for example, SiN, which covers the source electrode 106 completely, and forms a contact hole 109 in a part of the drain electrode 107. Further, the protection layer 108 covers the light receiving element first electrode 121 and the light receiving element second electrode 122.

The anode 112 formed on the protection layer 108 uses ITO (Indium-Tin-Oxide) in the embodiment. As the anode 112, except for the ITO, IZO (Indium-Zinc-Oxide), ATO (SnO₂ in which Sb is doped), AZO (AnO in which Al is doped), ZnO, SnO₂, or In₂O₃ can be used. Though the anode 112 can be formed by an evaporation method, it is desirable that it is formed by a sputter method or a CVC (Chemical Vapor Deposition) method. This anode 112 is connected to the drain electrode 107 through the contact hole 109.

On the surface of the anode 112, the pixel regulating part 118 is formed, and the light emission layer 114 is formed in contact with the whole of the anode 112 and the pixel regulating part 118 by a so-called wet process including a coating step of which a spin coating method is representative. Further, the cathode 116 is formed in contact with the light emission layer 114 by the evaporation method.

The drive conditions of the organic electroluminescence element 63 will be described later in detail.

In the embodiment, though the light emission layer 114 constituting the organic electroluminescence element 63 is composed of a single layer, it may be composed of plural layers such as a hole injection layer, an electron block layer, a light emission layer, and an electron injection layer (all the layers are not shown).

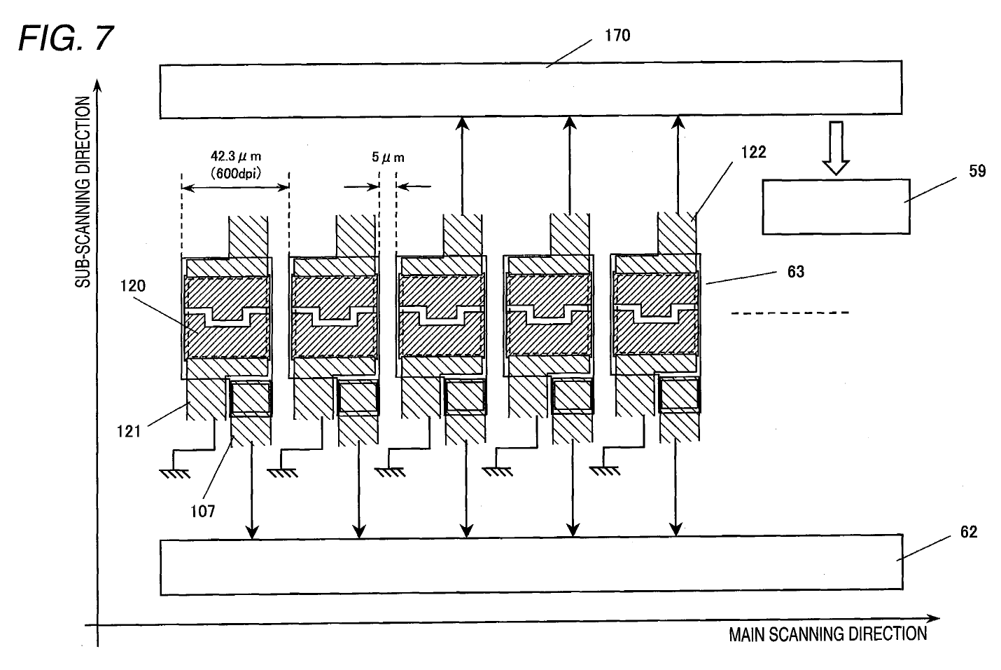

The pixel regulating part 118 exists between the anode 112 and the cathode 116 and regulates substantially a luminous area LA. In the embodiment, the light receiving element 120 is constituted so that the area of the light receiving element 120 which is formed in the shape of an island and formed of polysilicon (refer to FIG. 7. FIG. 7 shows a state where the light receiving elements 120 is formed discretely, that is, in the shape of an island.) becomes larger than at least the area of the luminous area LA. The difference-in-level produced by arranging the island-shaped light receiving element 120 formed of polysilicon extends generally to the structure above the light receiving element 120. However, by thus making the size of the light receiving element 120 larger than the size of the luminous area LA, even in case that there is the difference-in-level due to the light receiving element 120, the anode 112 can secure smoothness without receiving the influence of the difference-in-level. Therefore, even in case that the light emission layer 114 is formed on the anode 112 by a coating method (particularly, a manufacturing process for avoiding, as much as possible, unevenness of the portion in which the luminous area is formed, such as a printing method or an ink jet method), the film thickness of the light emission layer 114 is uniformized, and the distribution of the emitted light quantity in the luminous area LA can be made uniform. Since the size of the luminous area LA is regulated by the pixel regulating part 118 as described above, in a form on the substantial structure, by this pixel regulating part 118, the size of the luminous area LA is made smaller than the size of the island-shaped light receiving element 120 formed of polysilicon.

The TFT 102 is formed in one-to-one relation with each organic electroluminescence element 63, and constitutes electrically an active matrix circuit. The source electrode 106 is formed as a positive pole, the predetermined potential difference is provided between the source electrode 106 and the cathode 116, and further the gate electrode 104 is controlled at the predetermined potential. Hereby, holes are injected through the source electrode 106, the TFT 102, the drain electrode 107, and the anode 112 into the light emission layer 114. On the other, the electron is injected from the cathode 116 to the light emission layer 114. Re-combination of the hole and the electron is produced in the light emission layer 114, and when an exciton generated by this re-combination shifts from an excited state to a ground state, a light emission phenomenon arises.

The light emitted from the light emission layer 114 passes through the anode 112, the intermediate layer 105, the gate insulation layer 103, the light receiving element 120, the base coat layer 101 and the glass substrate 50 and is emitted from the surface opposite to the surface A, thereby to expose the not-shown photoconductor 8 (refer to FIG. 2). Since polysilicon is comparatively high in transparency, the light receiving element can be thus formed on the side from which the light is emitted.

The wiring pattern 119 is utilized to supply the analog signal of the light quantity correction data outputted from the source driver 61 shown in FIG. 4 to the pixel circuit.

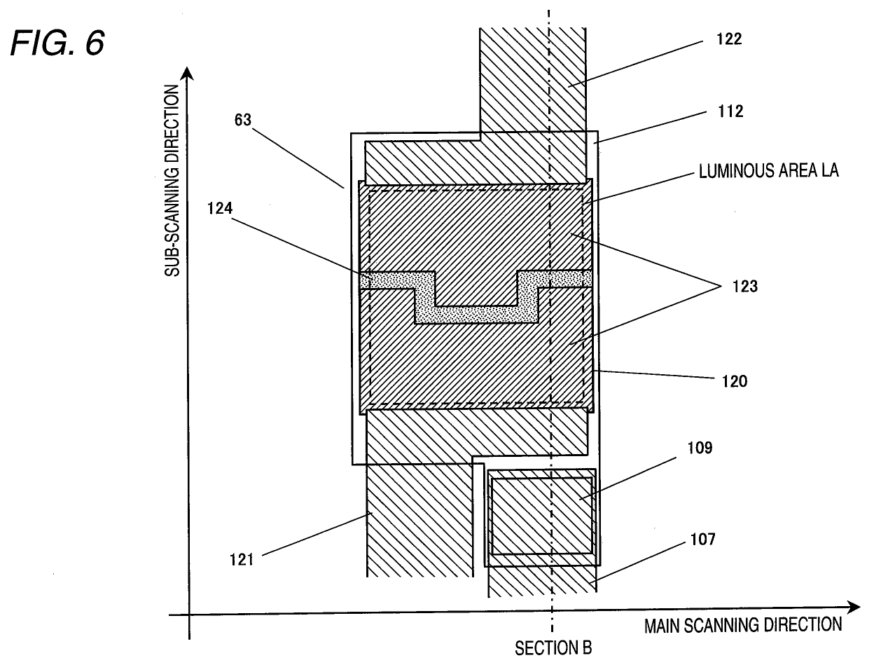

FIGS. 6 and 7 show respectively a top view of the organic electroluminescence element 63 included in the exposure unit 13 in the image forming apparatus 1 according to the first embodiment of the invention and a structure around the organic electroluminescence element 63. FIG. 6 is a top view of surroundings of one light receiving element 120, and FIG. 7 shows a top view in case that the many light receiving elements 120 are arranged. With reference to FIGS. 6 and 7, the light receiving element 120 and the structure around its light receiving element 120 will be described below.

As shown in FIG. 6, the light receiving element 120 formed of the island-shaped polysilicon has an electroconductive area 123 obtained by doping a phosphorus ion and a semiconductive area 124 to which ion doping is not applied. A length of a boundary line between the electroconductive area 123 and the semiconductive area 124 is set so as to become longer than at least one side of the luminous area LA. The photocurrent is caused by incidence of the emission light from the light emission layer 114 (refer to FIG. 5) formed above the light receiving element onto the semiconductive area 123, and its current density depends on the cross-sectional area of the boundary portion between the electroconductive area 123 and the semiconductive area 124. Therefore, by making the boundary line between them long, the photocurrent substantially outputted by the light receiving element 120 can be increased.

As shown in FIG. 7, the light receiving element 120 and the organic electroluminescence element 63 are formed in one-to-one relation. In this embodiment, pairs of them are arranged in the main scanning direction at 600 dpi, that is, at 42.3 μm pitches, and each space between the organic electroluminescence elements 63 is set to 5 μm. The light receiving element first electrode 121 is connected to the GND, and the light receiving element second electrode 122 is connected to the second TFT circuit 170 (refer to FIG. 4, as described before.

As shown in FIGS. 6 and 7, the anode 112 is formed in the shape in which a part on the pulling-out side of the light receiving element first electrode 121 is cut off, and connected through the contact hole 109 to the drain electrode 107. Namely, the electrode (drain electrode 107) which drives the organic electroluminescence element 63 and the electrode which outputs the photocurrent of the light receiving element 120 (light receiving element second electrode 122) are provided in two different directions in the sub-scanning direction. Hereby, on the both sides of the organic electroluminescence element 63 and light receiving element 120 array formed in the main scanning direction, the circuits can be formed independently, so that a space factor is improved.

As described before, the output from the light receiving element second electrode 122 is inputted to the second TFT circuit 170 composed of the switching circuit, and the output from the second TFT circuit 170 is selectively inputted in accordance with the predetermined sequence to the processing circuit 59 which is the correcting part (characteristic difference correcting part).

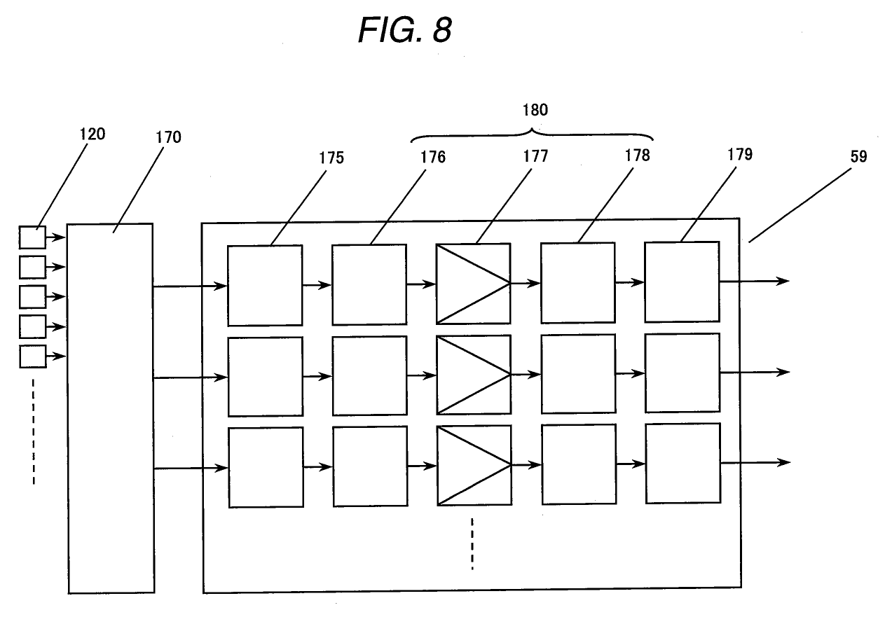

FIG. 8 is a block diagram showing the constitution of the processing circuit 59 included in the exposure unit 13 in the image forming apparatus 1 according to the first embodiment of the invention. The processing circuit 59 is an analog/digital mixed IC chip, which corrects the temperature characteristic of the light receiving element 120. With reference to FIG. 8, the constitution and function of the processing circuit 59 will be described below in detail.

The processing circuit 59 includes a voltage conversion circuit 175, a subtracter 176, an amplifier 177, an adder 178, and an A/D converter 170.

The voltage conversion circuit 175 converts the photocurrent caused by the light receiving element 120 (refer to FIG. 7) into voltage. The voltage conversion circuit 175 includes a condenser (not shown), and the inputted photocurrent is charged and stored by this condenser for the predetermined time. Naturally, in this charge period, the organic electroluminescence element 63 is controlled so as to emit the light, and since the charging time is controlled equally, the terminal voltage of the condenser increases and decreases according to the emitted light quantity of the organic electroluminescence element 63.

The subtracter 176 subtracts from the output of the voltage conversion circuit 175 the predetermined voltage level, that is, a predetermined offset value. Namely, the terminal voltage of the condenser in the voltage conversion circuit 175 is inputted to the subtracter 176, and the predetermined voltage level is subtracted by the subtracter 176. This “voltage level to be subtracted” is a value obtained by previously measuring the temperature characteristic of the light receiving element 120 (refer to FIG. 7), for example, a value obtained under “a condition where the emitted light quantity of the organic electroluminescence element 63, which is darkest, is detected”. More specifically, at the lowest temperature in an operation assurance range of the image forming apparatus, the organic electroluminescence element 63 is driven so that the emitted light quantity becomes equal to the emitted light quantity in the expiration of lifetime due to deterioration, and a value obtained by converting the photocurrent of the light receiving element 120 at this time into voltage by the voltage conversion circuit 175 is taken as the “voltage level to be subtracted”. Further, the condition as the basis may be changed according to specification of the processing system.

The amplifier 117 amplifies the output of the subtracter 176 with the predetermined amplification factor. The amplification factor of the amplifier 117 is set to a “value by which a difference in temperature characteristic between the light receiving element 120 constituting the light quantity measuring part and the photoconductor 8 (refer to FIG. 3) can be reduced” and a “value by which an input dynamic range of the A/D converter 179 is sufficiently secured for change in the emitted light quantity of the organic electroluminescence element 63 from the initial state to the lifetime expiration (A concrete example will be described later).

The adder 178 adds a predetermined voltage level, that is, a predetermined offset value to the output of the amplifier 177. This addition is performed in order to secure the minimum voltage level which can be converted by the A/D converter 179. In case that the subtracter 176 previously performs such adjustment that the minimum voltage level of the output of the amplifier 177 does not become negative, the adder 178 may be omitted.

The A/D converter 179 analog-to-digital converts the output of the adder 178, and the output of the adder 178 is converted into digital data at 8-bit accuracy.

Of the above parts, the subtracter 176, the amplifier 177 and the adder 178 constitute the level converter 180 which has been already described. Further, as shown in FIG. 8, the plural voltage conversion circuit 175, subtracters 176, amplifiers 177, adders 178, and A/D converts 179 are provided, and they process simultaneously the outputs of the plural light receiving elements 120 selected by the second TFT circuit 170.

The offset value added or subtracted by the adder 178 or the subtracter 176, and the amplification factor of the amplifier 177 can be adjusted from the outside of the processing circuit 59 by the engine control CPU of the engine control part (both are not shown) described later. Further, in the embodiment, the potentials of the addition and subtraction by the adder 178 and the subtracter 176, and a reference potential which determines a conversion range of the A/D converter 179 are supplied by a not-shown power supply provided in the processing circuit 59. However, these potentials may be supplied from the outside of the processing circuit 59.

The function of the processing circuit 59 will be described below with reference to FIG. 8. The photocurrent which has been caused by the light receiving element 120 (refer to FIG. 7) is inputted to the processing circuit 59 through the second TFT circuit 170 that is the switching circuit and a not-shown wiring, and thereafter outputted as digital data in which the temperature characteristic of the light receiving element 120 has been corrected.

Since the above constitution and function are provided for the processing circuit 59, by previously measuring the sensitivity characteristic of the photoconductor 8 (refer to FIG. 3) for the temperature (for example, characteristic indicating 1% sensitivity increase of the photoconductor 8 per 1° C. increase of temperature), and the sensitivity characteristic of the light receiving element 120 for the temperature (for example, characteristic indicating 0.25% sensitivity increase of the light receiving element 120 per 1° C. increase of temperature), and setting, on the basis of a result of this measurement, the offset values in the subtracter 176 and the adder 178 in the processing circuit 59 and the amplification factor of the amplifier 177, the temperature characteristic which the light receiving element 120 has can be substantially matched with the temperature characteristic of the photoconductor 8.

The output of the light receiving element 120 having the sensitivity increase rate of 0.25% per 1° C., after the 0-level has been adjusted in the subtracter 176, is quadrupled by the amplifier 177, whereby the temperature characteristic of the light receiving element 120 has the sensitivity increase rate of 1.0% per 1° C. Namely, the temperature characteristic of the light receiving element 120 can be equalized to that of the photoconductor 8 in semblance. However, since the appropriate dynamic range is necessary for the analog signal to be converted in the conversion time to digital data by the A/D converter 179 as described above, it is good to give the amplification factor of, for example, 1000 times in order to secure the dynamic range and also set the amplification factor for securing the dynamic range such as the whole amplification factor of 4000 times.

When the sensitivity of the light receiving element 120 increases by the increase of temperature, the above-mentioned level converter 180 in the processing circuit 59 detects that the emitted light quantity of the organic electroluminescence element 63 is larger, with the result that a light quantity correcting part described later tries to control the emitted light quantity of the organic electroluminescence element 63 smaller. On the other hand, since the sensitivity of the photoconductor 8 (refer to FIG. 3) increases by the increase of temperature, the photoconductor 8 functions so as to compensate the emitted light quantity which has been controlled smaller by the light quantity correcting part. The difference in temperature characteristic between the light receiving element 120 and the photoconductor 8 (refer to FIG. 3) is thus reduced, with the result that an image of high quality which does not vary in image quality even under every temperature environments can be formed.

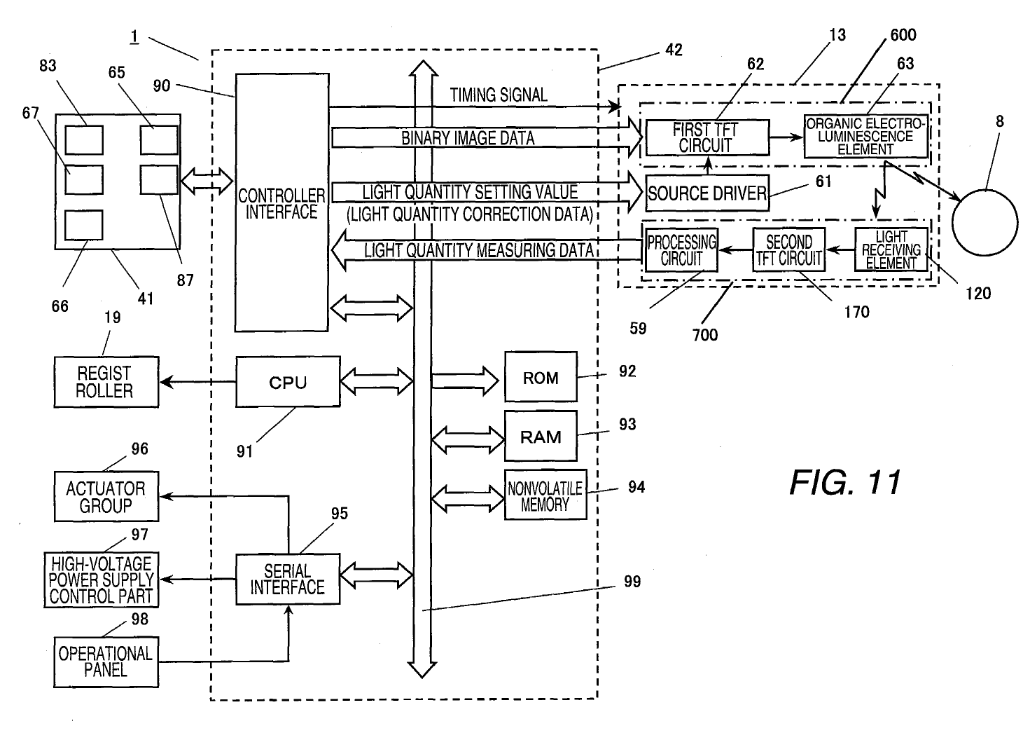

Strictly speaking, “in case that the temperature of the light receiving element 120 is equal to the temperature of the position of the photoconductor 8 corresponding to the position in the main scanning direction of the light receiving element 120′, the difference in temperature characteristic can be reduced by the above constitution of the processing circuit 59. Under the constitution of the embodiment, in order to meet this condition as much as possible, the protrusion part 57 is provided at the leading end of the exposure unit 13 as described before with reference to FIG. 3, thereby to make the temperature distributions of the light receiving element 120 and the photoconductor 8 equal. Namely, the image forming apparatus 1 in the first embodiment has the exposure unit 13 (refer to FIG. 3) including at least the light emission part (organic electroluminescence element 63) and the light quantity measuring part 700 (refer to FIG. 11), and further has the protrusion part 57 provided for the exposure unit as the temperature difference reducing part which reduces the temperature difference between the image bearing body (photoconductor 8) and the light quantity measuring part (light receiving element 12).

In case that the temperature difference between the light receiving element 12 and the photoconductor 8 has been previously known, the setting of the level converter 180 can be readily adjusted correspondingly.

Further, when the above constitution of the processing circuit 59 is adopted, even in case that the temperature characteristics of the photoconductor 8 and the light receiving element 120 are entirely contrary to the above example, that is, even in case that the sensitivity of the photoconductor 8 increases with the temperature increase and the sensitivity of the light receiving element 120 lowers with the temperature increase, an image of high quality which does not vary in image quality can be formed. Namely, by using a negative amplification factor as the amplification factor of the amplifier 177, it is possible to reduce the difference in temperature characteristic between them.

Thus, the image forming apparatus in the embodiment includes the image bearing body (photoconductor 8) which bears an image to be formed by the exposure, the light emission part (organic electroluminescence element 63) which emits light for exposing the image bearing body to the light, the light quantity measuring part 700 (refer to FIG. 11) which measures the quantity of the light emitted by the light emission part and outputs a light quantity measuring signal, and the characteristic difference correcting part (processing circuit 59) as the correcting part which reduces the difference between the change of the image density for the temperature of the image bearing body and the change of the light quantity measuring signal for the temperature of the light quantity measuring part.

Further, the function as the light quantity correcting part of the processing circuit 59 may be omitted. In this case, a sign indicating inclination (change rate) of the light quantity measuring signal of the light quantity measuring part for temperature is matched with a sign indicating inclination (change rate) of the density of the picture image formed by the image born by the photoconductor 8 for temperature of the photoconductor 8. In case that the inclination (change rate) of the image density of the photoconductor 8 is positive, the inclination (change rate) of the light quantity measuring signal is made positive (for example, the inclination (change rate) of the output signal of the light receiving element 120 is made positive). Thus by matching the signs of the inclination (change rates) with each other, as the sensitivity of the photoconductor 8 becomes higher with the temperature increase of the photoconductor 8, the light quantity measuring signal also becomes larger and operates so as to lower the drive signal of the light emission part 600. Therefore, it is possible to suppress the change in image density caused by the temperature change.

More specifically, by matching the sign indicating inclination (change rate) of the light quantity measuring signal of the light quantity measuring part for the temperature (for example, a sign indicating the increase in output of the light receiving element 120 in accordance with the increase of temperature, that is, a plus sign) with the sign indicating inclination (change rate) of the density of the picture image formed by the image born by the photoconductor 8 for the temperature of the photoconductor 8 (for example, a sign indicating the increase in image density with the increase of temperature, that is, a plus sign), as setting of the above-described processing circuit 59, only the amplification factor of 1000 times may be given in order to secure the dynamic range. Hereby, the both temperature characteristics of the light quantity measuring part and the photoconductor act so as to offset each other resultantly.

Namely, the image forming apparatus according to the embodiment includes the image bearing body (photoconductor 8) which bears the image formed by the exposure, the light emission part (organic electroluminescence element 63) which emits light for exposing the image bearing body to the light, the light quantity measuring part 700 (refer to FIG. 11) which measures the quantity of the light emitted by the light emitted part, and the light quantity control part (controller 41 described later, and particularly controller CPU 83) which controls the quantity of the light emitted by the light emission part so that the light quantity measuring signal outputted by the light quantity measuring part 700 becomes the predetermined value, wherein the temperature characteristic of the image bearing body and the temperature characteristic of the light quantity measuring part are offset by each other.

Further, in the embodiment, the sign indicating inclination (change rate) of the light quantity measuring signal of the light quantity measuring part for the temperature is matched with the sign indicating inclination (change rate) of the density of the picture image formed by the image born by the photoconductor 8 for temperature of the photoconductor 8. As described before, the density change of the image on the photoconductor 8 for the temperature change is caused by the sensitivity change of the photoconductor 8 with the temperature change. Accordingly, even in case that the “inclination (change rate) of the image density” said here may be “inclination of the change amount (change rate) of the surface potential of the photoconductor 8 when the predetermined quantity of light (the predetermined energy in case that it is specified by time) is applied on the image surface of the photoconductor 8 which has been previously charged with the predetermined potential, “inclination of the change amount (change rate) of the area surrounded by the specified equipotential line when the light spot having the predetermined size is formed on the image surface of the photoconductor 8” or “inclination of the change amount (change rate) of weight of toner transferred on the photoconductor 8 and born by the photoconductor 8. In these cases, the substantially same working effect can be obtained. Namely, it is good that the sign indicating inclination (change rate) of the light quantity measuring signal of the light quantity measuring part for the temperature (for example, a sign indicating the output increase in accordance with the increase of temperature, that is, a plus sign) is matched with the sign indicating inclination (change rate) of the sensitivity of the photoconductor 8 for the temperature (for example, the sign indicating the increase in sensitivity of the photoconductor 8 with the increase of temperature, that is, a plus sign).

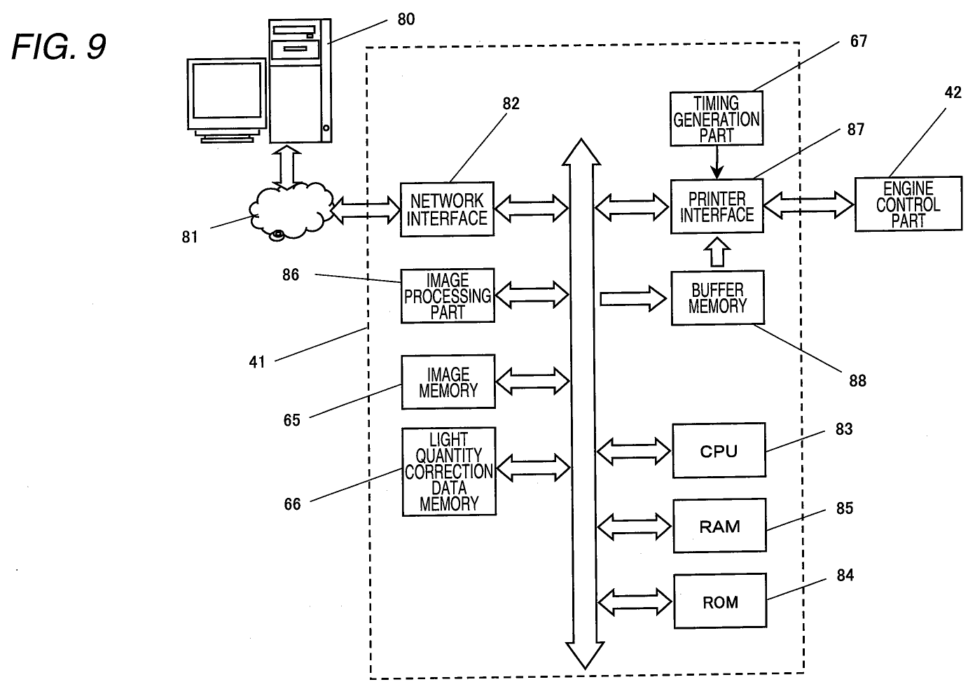

FIG. 9 is a block diagram showing the constitution of the controller 41 in the image forming apparatus 1 according to the first embodiment of the invention. With reference to FIG. 9, the operation of the controller 41 will be described below and the light quantity correction will be described more detailedly.

The controller 41 in FIG. 9, on the basis of image data and print job information, expands image data into printable binary image data, and includes a network interface 82, a controller CPU 83, a ROM 84, a RAM 85, an image processing part 86, a printer interface 87, a buffer memory 88, an image memory 65, a light quantity correction data memory 66, and a timing generation part 67.

The network interface 82 transmits and receives data between it and a computer 80 connected to a network 81. The computer 80 transfers print job information such as image data, the number of printing sheets and a print mode (for example, color/monochrome) through the network 81 to the controller 41, and receives so-called status information such as error information detected on the image forming apparatus side.

The controller CPU 83, on the basis of a program stored in the ROM 84, controls the operation of the controller 80. The RAM 85 is used as a work area of the controller CPU 83, and stores temporarily the image data and the print job information which have been received through the network interface 82.

The image processing part 86, on the basis of the image data and the print job information which have been transferred from the computer 80, performs image processing (for example, image expansion processing on the basis of printer language, color correction, edge correction, and screen generation) by the page thereby to generate printable binary image data, and stores this binary image data in the image memory 65 by the page. The light quantity correcting data memory 66 stores light quantity correcting data, and is composed of a rewritable nonvolatile memory such as EEPROM.

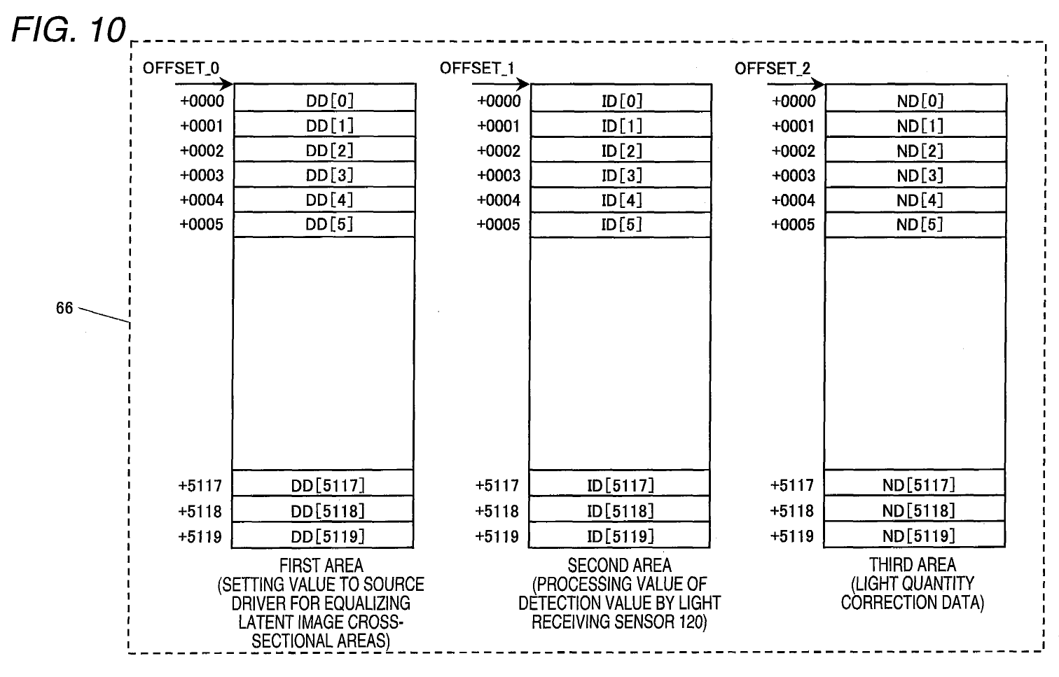

FIG. 10 is an explanatory view showing contents of the light quantity correction data memory 66 in the image forming apparatus 1 according to the first embodiment of the invention. With reference to FIG. 10, data structure and data contents in the light quantity correction data memory will be described below.

As shown in FIG. 10, the light quantity correction data memory 66 has three areas of first to third areas. Each area includes 8-bit data of the number (5120) that is equal to the number of the organic electroluminescence elements 63 (refer to FIG. 4) constituting the exposure unit 13 (refer to FIG. 13), and the areas possess 15360 bytes in total.

Firstly, data DD [0] to DD [5119] stored in the first area will be described with reference to FIGS. 10, 3 and 4.

The above-described exposure unit 13 includes the step of adjusting the light quantity of each organic electroluminescence element 63 in its manufacturing process. In this step, the exposure unit 13 is attached to a predetermined jig (not shown), and ON of the organic electroluminescence elements 63 are individually controlled on the basis of the control signals supplied from the outside of the exposure unit 13.

Further, by a CCD camera provided for a jig (not shown), the two-dimensional light quantity distribution of each organic electroluminescence element 63 in the image surface position of the photoconductor 8 is measured. The jig (not shown) calculates, on the basis of this light quantity distribution, the potential distribution of the latent image formed on the photoconductor 8, and further calculates the latent image cross-section area which is high in correlation with toner attachment quantity on the basis of the actual development conditions (development bias value and surface potential of photoconductor 8). The jig (not shown) changes a drive current value for driving the organic electroluminescence element 63 (As described before, by programming an analog value in the pixel circuit constituting the first TFT circuit 62 through the source driver 61, the current value for driving the organic electroluminescence element 63 is set.), and extracts such a drive current value that all the latent image cross-section areas formed by the respective organic electroluminescence elements 63 become nearly equal, that is, a setting value to the pixel circuit (from a viewpoint of control, setting data to the source driver 61).

In the first area of the light quantity correction data memory 66, the thus obtained setting data to the source driver 61 is stored. The number of the setting data is 5120, which is equal to the number of the organic electroluminescence elements 63 constituting the exposure unit 13 as described before (that is, equal also to the number of pixel circuits). Thus, in the first area of the light quantity correction data memory 66, the “setting data to the source driver 61 for equalizing the latent image cross-sectional areas formed by the respective organic electroluminescence elements 63 in the initial state” is stored.

Next, data ID [0] to ID [5119] stored in the second area will be described with reference to FIGS. 10, 3, 4 and 9.

The before-mentioned jig (not shown) acquires the data stored in the first area, and simultaneously acquires, on the basis of the output of the light receiving element 120 (refer to FIG. 4), through the processing circuit 59 of the exposure unit 13 the 8-bit light quantity measuring data that has been already described. Hereby, the “light quantity measuring data when the latent image cross-section areas formed by the respective organic electroluminescence elements 63 are equalized in the initial state” can be acquired. In the second area, this 8-bit light quantity measuring data ID[n] are stored.

Thus, in the manufacturing process of the exposure unit 13, the data stored in the first and second areas area are acquired, and these data are written by a not-shown electric communication unit from the jig into the light quantity correction data memory 66.

Next, data ND [0] to ND [5119] stored in the third area will be described with reference to FIGS. 10, 3, 4 and 9.

The image forming apparatus 1 in the first embodiment of the invention has the light quantity correcting part (that is, controller CPU 83 shown in FIG. 9) which corrects the light quantities of the respective organic electroluminescence elements 63 nearly equally on the basis of the measuring result by the light receiving elements 120 constituting the light quantity measuring part. On the basis of the output of this light quantity correcting part, the light quantity setting part (controller CPU 83) sets the light quantity of each organic electroluminescence element 63 in the image formation.

Into the third area, the setting value of the light quantity of each organic electroluminescence element 63 in the image formation, that is, the light quantity correction data is written by the controller CPU 83 which is the light quantity correcting part.

In the embodiment, as described above, the light quantities of the organic electroluminescence elements 63 constituting the exposure unit 13 are measured in the operation of initialization of the image forming apparatus 1, in the starting time of the image forming operation, at the paper interval period, and in the completion time of the image forming operation. The controller CPU 83 generates light quantity correction data on the basis of the light measuring data measured at these points of time, the “setting data to the source driver 61 for equalizing the latent image cross-sectional areas formed by the respective organic electroluminescence elements 63 in the initial state” stored in the first area in the manufacturing process of the exposure unit 13, and the “light quantity measuring data when the latent image cross-section areas formed by the respective organic electroluminescence elements 63 are equalized in the initial state” stored in the second area in the manufacturing process of the exposure unit 13.

The calculation contents of the light quantity correction data by the controller CPU 83 will be described below. When the “setting data to the source driver 61 for equalizing the latent image cross-sectional areas formed by the respective organic electroluminescence elements 63 in the initial state” stored in the first area is taken as DD[n] (n indicates number of each organic electroluminescence element 63 in the main scanning direction, which is the same hereinafter), the “light quantity measuring data when the latent image cross-section areas formed by the respective organic electroluminescence elements 63 are equalized in the initial state” stored in the second area is taken as ID[n], and the light quantity measuring data measured newly in the operation of initialization and the like is taken as PD[n], new light quantity correction data ND[n] to be written into the third area is generated on the basis of ND[n]=DD[n]×ID[n]/PD[n] (n indicates number of each organic electroluminescence element 63 in the main scanning direction).

Turning to FIG. 9, the description will be continued below. The thus generated light quantity correction data ND [n] is written once into the third area (refer to FIG. 10) of the light quantity correction data memory 66. Thereafter, prior to the image formation, the light quantity correction data ND[n] is copied from the light quantity correction data memory 66 to the predetermined area of the image memory 65. In order to form an image, the light quantity correction data ND [n] copied to the image memory 65 is temporarily stored into the buffer memory 88 described later together with the binary image data, and outputted through the printer interface 87 to the engine control part 42.

The buffer memory 88 stores once the binary image data and the light quantity correction data stored in the image memory in order to transfer them to the engine control part 42. The buffer memory 88 is composed of a so-called dual port RAM in order to absorb a difference between a data transfer speed from the image memory 65 to the buffer memory 88 and a data transfer speed from the buffer memory 88 to the engine control part 42.

The printer interface 87 transfers the binary image data in pages and the before-mentioned light quantity correction data which have been stored in the image memory 65 through the printer interface 87 to the engine control part 42 in synchronization with a clock signal and a line synchronization signal which are generated by the timing generation part 67.

As described above, the controller 41 expands the reception data to generate the printable binary image data, and controls the emitted light quantity of the light emission part 600 (refer to FIG. 11) so that the light quantity measuring signal from the light quantity measuring part 700 (refer to FIG. 11) becomes the predetermined value.

FIG. 11 is a block diagram showing the constitution of the engine control part 42 in the image forming apparatus 1 according to the first embodiment of the invention. Referring to FIGS. 11 and 1, the operation of the engine control part 42 will be described below in detail.

The engine control part 42 in FIG. 11 includes a controller interface 90, an engine control CPU 91, a ROM 92, a RAM 93, a nonvolatile memory 94, a serial interface 95, and a bus 99.

The controller interface 90 receives the light quantity correction data and the binary image data in pages which are transferred from the controller 41.

The engine control CPU 91, on the basis of a program stored in the ROM 92, controls the image forming operation in the image forming apparatus 1. The RAM 93 is used as a work area when the engine control CPU 91 operates. The nonvolatile memory 94, which is a so-called a rewritable memory such as EEPROM, stores information on the lifetime of components of the image forming apparatus 1 such as rotating time of the photoconductor 8 and operating time of the fuser 23 (refer to FIG. 1).

The serial interface 95, after the information from a sensor group including the recording sheet passage detecting sensor 21 (refer to FIG. 1) and the recording sheet rear end detecting sensor 28 (refer to FIG. 1) and the output of the power supply monitoring part 44 (refer to FIG. 1) have been converted into serial signals having the predetermined cycle by a not-shown serial conversion unit, receives their serial signals. The serial signals received by the serial interface 95 are converted into parallel signals and thereafter read through the bus 99 by the engine control CPU 91.

A control signal for an actuator group 96 including an electromagnetic clutch (not shown) which controls start/stop of the feed roller 18 and the drive source 38 (refer to FIG. 3), and the drive power transmission to the feed roller 18 (refer to FIG. 1), and a control signal for a high-voltage power control part 97 which controls potential setting of the development bias, the transfer bias, and the charge potential are sent as parallel signals to the serial interface 95. Then, the serial interface 95 converts the parallel signals into serial signals and outputs the serial signals to the actuator group 96 and the high-voltage power control part 97. Thus, in the embodiment, the sensor input and the output of the actuator control signal which do not require the high-speed detection are performed in their entirety through the serial interface 95. On the other, a signal requiring high speed of some degree, for example, a control signal for driving and stopping the regist roller 19 is directly connected to the output terminal of the engine control CPU 42.

An operational panel 98 is used for user's operation of the image forming apparatus 1, which is connected to the serial interface 95. User's instruction for the operational panel 98 is recognized through the serial interface 95 by the engine control CPU 91. The image forming apparatus 1 in the embodiment has an operational panel as an instruction input unit by which the user's instruction is inputted, and measures, on the basis the input to this operational panel, the light quantity of the organic electroluminescence element 63 constituting the exposure unit 13 thereby to correct the light quantity. This instruction may be given from the external computer through the controller 41. As the concrete form of use, it is assumed that: in case that the user has found unevenness of density on the printing surface when a large quantity of printing has been performed, he corrects forcedly the light quantity thereby to secure the image quality. In case that the image forming apparatus 1 is in a waiting state, the user can instruct the image forming apparatus 1 on the forced execution of the light quantity correction at any time. Further, even in the image forming time, the user shifts the image forming apparatus 1 to an off-line state and holds the image formation temporarily, whereby he can instruct the image forming apparatus 1 on the execution of the light quantity correction.

In any case, when a light quantity correction request is inputted from the operational panel 98 as the instruction unit, the engine control CPU 91, as described in the operation of initialization, starts to drive the components of the image forming apparatus 1, and outputs to the controller 41 a creation request of dummy image data for light quantity correction. On the basis of this request, the controller CPU 83 mounted on the controller 41 creates the dummy image data for light quantity correction, and ON-control of the organic electroluminescence elements 63 constituting the exposure unit 13 is performed on the basis of this dummy image data. At this time, the above-mentioned light receiving element 120 provided for the exposure unit 13 detects the light quantity of each organic electroluminescence element 63, and corrects on the basis of a result of this light quantity detection the light quantity so that the light quantities of the respective organic electroluminescence elements 63 become nearly equal. At this time, as described before, the difference in temperature characteristic between the light receiving element 120 and the organic electroluminescence element 63 is reduced by the processing circuit 59 which is the correction part (characteristic difference correcting part).

Next, the operation when the light quantity of the organic electroluminescence element 63 is measured will be described in detail with reference to FIGS. 11, 1 and 10.

As described before, the correction of the light quantity is performed in the operation of initialization immediately after a start of the image forming apparatus 1, before a start of printing, in the paper interval period, after a start of printing, and at timing specified by the user through the operational panel 98. For the purpose of simplifying the description, a case where the light quantity measurement is executed in the operation of the initialization of the image forming apparatus 1 will be described. Further, though the image forming apparatus 1 in the embodiment is constituted so that it can form a full color image, and has the exposure units 13Y to 13K (refer to FIG. 1) corresponding to four colors as described before, only the operation for one color will described for the purpose of simplifying the description and the exposure units 13Y to 13K will be described as the exposure unit 13. Further, in the following condition, for example, the drive source 38 (refer to FIG. 1) and the development station 2 (refer to FIG. 2) have been already started as described in the operation of initialization in detail.

Since the image forming operation of the image forming apparatus 1 is controlled by the engine control part 42, a sequence for light quantity correction is controlled by the engine control CPU 91 of the engine control part 42. Firstly, the engine control CPU 91, to the controller 41, outputs a creation request of dummy image data which is different from the proper binary image data relating to the image formation.

The engine control part 42 and the controller 41 are connected by a bidirectional serial interface (not shown), and can give and take a request command (request) and an acknowledgement (response information) for this command mutually. The creation request of dummy image data made by the engine control CPU 91 is outputted by means of this bidirectional serial interface (not shown) through the bus 99 from the controller interface 90 to the controller 41.

On the basis of this request, the controller CPU 83 mounted on the controller 41 creates dummy image data, that is, binary image data used for the light quantity measurement into the image memory 65 directly. Further, the controller CPU 83 reads out the DD[n] (n: 0 to 5119) which is the “setting data to the source driver 61 for equalizing the latent image cross-sectional areas formed by the respective organic electroluminescence elements 63 in the initial state” stored in the first area (refer to FIG. 10) of the light quantity correction data memory 66, and writes this value into the predetermined area of the image memory 65. Upon completion of these processing, the controller CPU 83 outputs the response information through the printer interface 87 to the engine control part 42.

The engine control CPU 91 of the engine control part 42 which has received this response information sets immediately write timing for the exposure unit 13. Namely, the engine control CPU 91 sets, in timers that are not-shown hardware, write timing of an electrostatic latent image by the exposure unit 13, and starts the operation of the timers immediately upon reception of the response information. Each timer, when the predetermined set time has passed, outputs an image data transfer request to the controller 41. The controller 41, after receiving the image data transfer request, transfers the binary image data to the exposure unit 13 in synchronization with timing signals (clock signal and line synchronization signal) generated by the timing generation part 67 through the controller interface 90. Simultaneously with this operation, the setting value (DD[n]) of the light quantity which has been already written into the image memory 65 is also transferred to the exposure unit 13 in synchronization with the above timing signals. Not in the light quantity measuring time but in the normal image forming time, the light quantity correction data (before-described ND[n]) is supplied through the same transfer path to the exposure unit 13 in place of the setting value of the light quantity.

Thus, the binary image data transferred in synchronization with the timing signals is inputted in the first TFT circuit 62 of the exposure unit 13, and simultaneously, the setting value of the light quantity is inputted in the source driver 61 of the exposure unit 13. In the exposure unit 13, on the basis of the inputted binary image data, that is, ON/OFF information, ON/OFF control of the corresponding organic electroluminescence element is performed. The emitted light quantity of each organic electroluminescence element 63 at this time is measured by the light receiving element 120 as described before.

The organic electroluminescence element 63 which becomes an object of measurement of the light quantity is determined by the dummy image data generated by the controller CPU 83. Namely, the emitted light quantity of the organic electroluminescence element 63 set to ON in the dummy image data is measured by the light receiving element 120. Therefore, though the second TFT circuit 170 selects the light receiving element 120 corresponding to the organic electroluminescence element 63 which has been caused to emit the light, it applies the output signal of the first TFT circuit 62 at this time, whereby the circuit scale can be reduced.

Since the light receiving elements 120 are provided in one-to-one relation with the organic electroluminescence elements 63, it is also thought that all the organic electroluminescence elements 63 are simultaneously caused to emit the light, and the emitted light quantities of them are measured by the light receiving elements 120 all at once. However, its thought is substantially difficult considering the existence of optical crosstalk by the adjacent organic electroluminescence elements 63, and the hardware scale which processes the outputs of the light receiving elements 120. Therefore, such the constitution is desirable that the organic electroluminescence elements 63 are caused to emit the light, for example, at intervals of eight (that is, the emitted light quantities of the adjacent organic electroluminescence elements 63 are not measured simultaneously), and these emitted light quantities are received by the light receiving elements 120 provided in the one-to-one relation with the organic electroluminescence elements 63. As described before, since the dummy image data is generated by the controller CPU 83, this data can be set freely by the program, which is a large merit.

The description will be continued below referring also to FIG. 2. Generally, in the image forming apparatus which applies an electrophotographic process, an isolated minute electrostatic latent image is difficult to be developed with resolution of about 600 dpi. Therefore, by not measuring simultaneously the emitted light quantities of the adjacent organic electroluminescence elements 63, the wasteful consumption of toner can be reduced, and it is also possible to suppress: that the toner adheres to the transfer roller 16 which rotates in contact with the photoconductor 8, the toner which has adhered to the transfer roller 16 adheres to the back surface of the recording sheet 3, and the recording sheet 3 is stained with the toner attached onto the back surface of the recording sheet 3.

Further, in the measuring time of the emitted light quantity, the emitted light quantity of the organic electroluminescence element 63 may be set smaller than the emitted light quantity in the printing time on the basis of the usual image data. Further, in the measuring time of the emitted light quantity, it is desirable that: when the exposed area of the photoconductor 8 by turning on the organic electroluminescence element 63 comes close to the development sleeve 10 and passes through a so-called developing area, that is, for the area of the photoconductor 8 exposed in the period of measuring the light quantity of the organic electroluminescence element 63, the development bias to be applied to the development sleeve 10 is set to OFF. Hereby, the toner attachment onto the photoconductor 8 can be prevented more effectively.

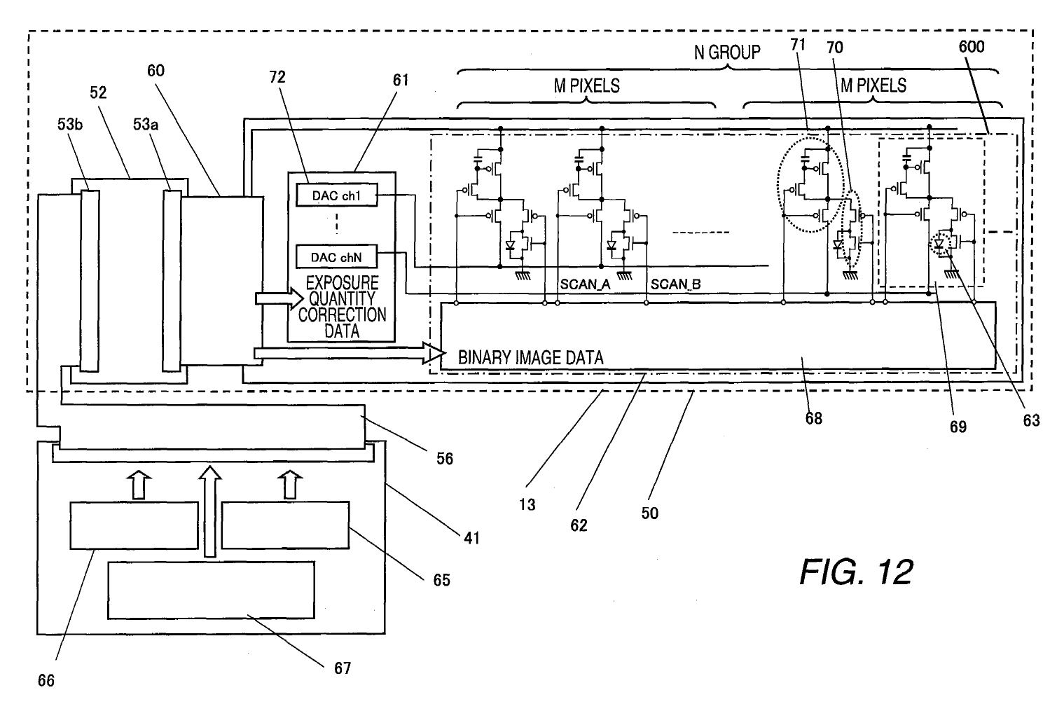

FIG. 12 is a circuit diagram of the exposure unit 13 in the image forming apparatus 1 according to the first embodiment of the invention. With reference to FIG. 12, the ON-control by the first TFT circuit 62 and the source driver 61 will be described below more detailedly.

The exposure unit 13, as described before, includes the relay board 52 having connectors 53a and 53b, and the glass substrate 50 on which the organic electroluminescence elements 63 are mounted. On the glass substrate 50, the source driver 61 and the first TFT 62 are formed.

The first TFT circuit 62 is divided broadly into the pixel circuit 69 and the gate controller 68. The pixel circuits 69 are provided one by one for the respective organic electroluminescence elements 63 and form one group consisting of the organic electroluminescence elements 63 of M-pixels, and N-groups of the pixel circuits 69 are provided on the glass substrate 50.

In the embodiment, one group consists of 16 pixels (that is, M=16) and 320 groups are formed. Accordingly, the total number of pixels amounts to 16×320 =5120. Each pixel circuit 69 includes a driver part 70 which supplies electric current to the organic electroluminescence element 63 and drives the organic electroluminescence element 63, and a current program part 71 which stores in a condenser including therein a current value supplied by the driver when the ON-control of the organic electroluminescence element 63 is performed (that is, a drive current value for the organic electroluminescence element 63). The pixel circuit 69, in accordance with the drive current value programmed at the predetermined timing, can constant-current drive the organic electroluminescence element 63.

The gate controller 68 includes a shift register which shifts the inputted binary image data in order; a latch part which is provided in parallel to the shift register and holds, after input of data having the predetermined pixel number in the shift register has been completed, these data in a lump; and a control part which controls these operation timing (these parts are not shown). The gate controller 68 receives from the controller 41 the binary image data (the image data converted by the controller 41 in the image forming time, and the dummy image data generated by the controller 41 in the light quantity measuring time), and outputs, on the basis of this binary image data, that is, ON/OFF information, a SCAN_A signal and a CAN_B signal, thereby to control timing of the period in which ON/OFF of the organic electroluminescence element 63 connected to the pixel circuit 69 is performed, and timing of the current program period for setting the drive current.

Further, the source driver 61 has therein D/A converters 72 of which the number corresponds to the group number N (320 in the first embodiment) of the organic electroluminescence elements 63. The source driver 61, on the basis of the 8-bit light quantity correction data (ND[n] shown in FIG. 6 in the image forming time, and DD[n] shown in FIG. 10 in the light quantity measuring time) supplied through the FPC 60, sets the drive current for each organic electroluminescence element 63. By this constitution, in the image forming time, the light quantities of the respective organic electroluminescence elements 63 are controlled uniformly by the before-mentioned light quantity correction data ND[n]; and in the light quantity measuring time, the light quantities of the respective organic electroluminescence elements 63 are controlled uniformly by the data DD[n].

As described above, the image forming apparatus 1 in the embodiment includes the photoconductor 8 which is the image bearing body that bears an image formed by the exposure, the light emission part 600 which emits light for exposing the photoconductor 8 to the light, and the light quantity measuring part 700 which measures the quantity of the light emitted from the light emission part 600 and outputs the light quantity measuring signal. Here, the light emission part 600 includes the first TFT circuit 62 and the organic electroluminescence element 63, and the light quantity measuring part 700 includes the light receiving element 120, the second TFT circuit 170, and the processing circuit 59. The light quantity measuring signal outputted from the light quantity measuring part 700 is sent to the controller 41, and the controller 41 outputs the light quantity correction data so that the inputted light quantity measuring signal is the predetermined value, and drives the light emission part 600 through the source driver 61.

In the image forming apparatus 1, the sign indicating inclination (change rate) of the light quantity measuring signal of the light quantity measuring part 700 for temperature is matched with the sign indicating inclination (change rate) of the density of the picture image formed by the image born by the photoconductor 8 for temperature. Accordingly, as the sensitivity of the photoconductor 8 becomes higher with the temperature increase of the photoconductor 8, the light quantity measuring signal also becomes larger and operates so as to lower the drive signal for the light emission part 600. Therefore, it is possible to suppress the change in image density caused by the temperature change.

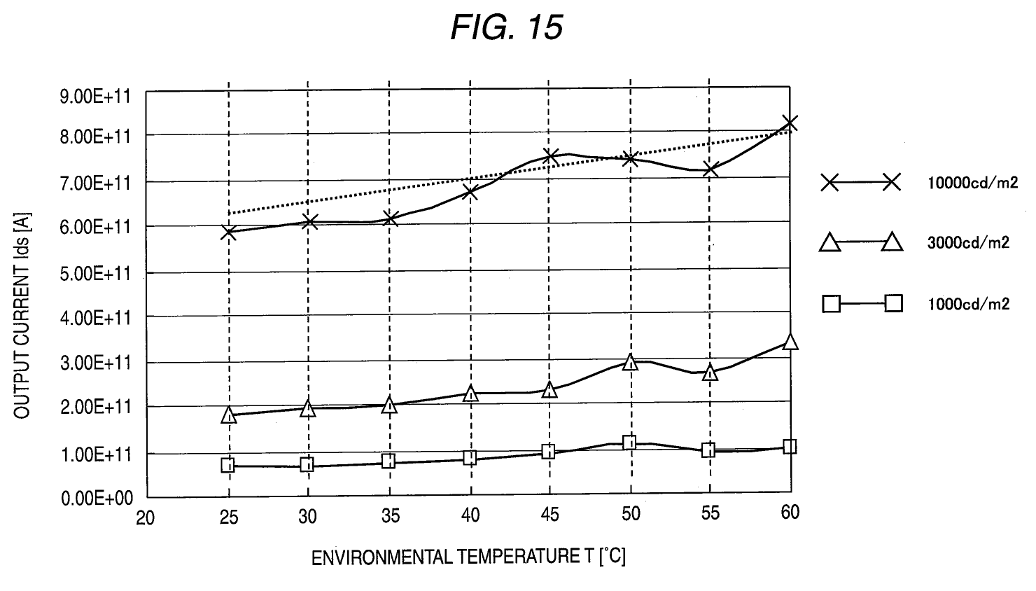

FIG. 15 is a characteristic diagram showing one example of a relation between output current Ids of the light receiving element 120 formed of polysilicon and the temperature T. In FIG. 15, output current values when the light receiving element receives the predetermined light quantities (10000 cd/m², 3000 cd/m², and 1000 cd/m²) are indicated as the respective types. The emitted light quantity in case that the organic electroluminescence element 63 is applied to the exposure unit requires about 10000 cd/m². In case that the organic electroluminescence element 63 is caused to emit the light with such a high luminance, the output-to-temperature current value of the light receiving element 120 has a clear tendency, and the output current value of the light receiving element increases with the increase of temperature.

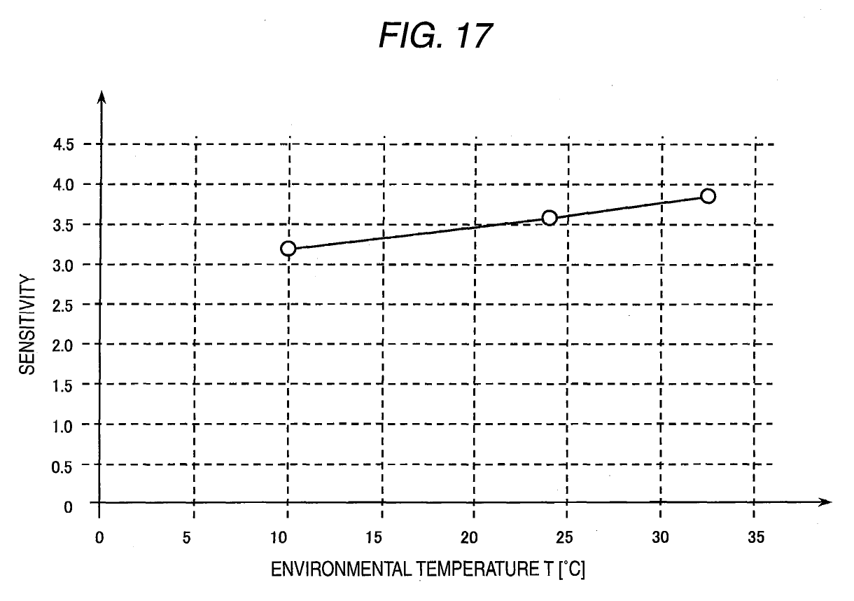

On the other hand, the photoconductor 8 has temperature characteristic for sensitivity as shown in FIG. 17. Accordingly, the sign indicating inclination (change rate) of the density of the picture image formed by the image born by the photoconductor 8 for temperature is matched with the sign indicating inclination (change rate) of the output of the light receiving element 120 for temperature. In the processing circuit 59, only by amplifying the output of the light receiving element 120 at the predetermined amplification factor and thereafter converting the amplified output into a digital signal, the change of the image density due to the temperature change can be suppressed.

There is a case where the sign indicating inclination (change rate) of the density of the picture image formed by the image born by the photoconductor 8 for temperature is different from the sign indicating inclination (change rate) of the output of the light receiving element 120 for temperature by the kind of photoconductor 8, the image forming method, and the kind of the light receiving element 8. In this case, by the processing circuit 59, the light quantity measuring signal to the controller 41 is corrected. For example, by taking a difference between the output from the light receiving element 120 and the predetermined value, and amplifying this difference, the inclination (change rate) of the light quantity measuring signal for the temperature can changed. According to the constitution of the before-mentioned processing circuit 59, it is clear that this correction can be readily performed.

Further, in case that the processing circuit 59 has the function of the correction part (characteristic difference correcting part) which reduces the difference between the temperature characteristic of the light quantity measuring part 700 and the temperature characteristic of the photoconductor 8, since the drive signal on the basis of the light quantity measuring signal corrects the temperature characteristic of the photoconductor, the change of the image density can be suppressed more.

As described before, the light emission part 600 and the light quantity measuring part 700 are formed on the same glass substrate 50. If the luminous efficacy of the organic electroluminescence element 63 becomes low and the heat generation of the light emission part 600 becomes large, the light quantity measuring part 700 also receives an influence of the heat generation thereby to become high in temperature. In this case, a temperature difference is produced between the light quantity measuring part 700 and the photoconductor 8, so that it is difficult to offset their mutual temperature characteristics.

Therefore, in the invention, by making the size (area) and drive conditions of the organic electroluminescence element 63 appropriate, the heat generation of the organic electroluminescence element 63 is suppressed. Hereby, the temperature difference between the light quantity measuring part 700 and the photoconductor 8 is reduced.

Generally, the emission luminance of the organic electroluminescence element 63 can be increased by increasing the current value for driving the element. It is known well that: in case of a green light emitting element, the drive current value and the emission luminance are in a proportional relation in the area of the low luminance of about 1000 cd/m². However, as the emission luminance increases, a ratio of the increase of the luminance to the increase of the drive current value becomes lower.

It is thought that this is because: since the drive voltage applied to the organic electroluminescence element 63 is increased in order to increase the drive current value, the electric field strength applied to the organic electroluminescence element 63 becomes very large, so that the balance of mobility between the electron and the hole which have been injected in the light emission layer is lost thereby to cause lowering of efficiency of re-combination of the electron and the hole. Although the detailed mechanism has not been known, this fact also causes that the required electric power becomes large in case that the element is driven at super high luminance.

Further, when the organic electroluminescence element 63 is constant-current driven, its luminance lowers with the drive time. The larger the drive current is, the more quickly the lifetime of the organic electroluminescence element 63 lowers. This cause, though it is being analyzed zealously, has not been made clear enough yet. As assumed causes, there are various causes such as reaction of the organic electroluminescence element with oxygen and hydrogen which will be included a little, reaction between the luminous materials in a state where the hole and the electron are moving, diffusion of the metal material used in the cathode, and diffusion of indium oxide used as the transparent electrode. It is thought that the luminance lowers in combination of these causes. When the organic electroluminescence element 63 was used as the exposure unit 13 (refer to FIG. 3) mounted on, for example, an electrophotographic apparatus unit and driven by energy necessary to expose the photoconductor 8 (refer to FIG. 3) to the light, the lifetime of the element became short due to these causes, so that a practical use of the element was too far.

Further, the recent electrophotographic apparatus such as a printer or MFP (Multi functional Printer) requires higher printing speed, and even a low-price machine requires ten or more printing sheets per one minute in the market. As the printing speed increases, the energy for forming the latent image on the photoconductor 8 must be applied to the photoconductor 8 in a shorter time, so that stronger emission luminance is required. This means that the lifetime of the organic electroluminescence element 63 becomes short.

On the other hand, it has been known that the lifetime of the organic electroluminescence element 63 becomes shorter as the luminance becomes higher, and in case that the organic electroluminescence element 63 is caused to emit the light with super high luminance of several 1000 to several 10000 cd/m² or more, its lifetime becomes considerably shorter than the lifetime estimated from an acceleration coefficient indicating a relation between the emission luminance and the lifetime in the low luminance, so that the organic electroluminescence element 63 could not be applied to the exposure unit used in the electrophotographic apparatus.

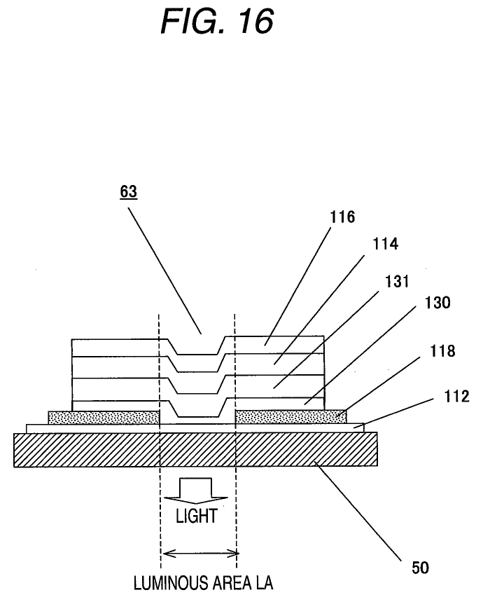

FIG. 16 is a sectional view showing the schematic constitution of the organic electroluminescence element 63 used as a light source in the first embodiment.

With reference to FIG. 16, the constitution of the organic electroluminescence element 63 in the embodiment will be described below in detail. Further, size conditions and drive conditions of the organic electroluminescence element 63 in the embodiment will be described in detail.

By satisfying these conditions, the organic electroluminescence element 63 can be caused to emit the light with very high efficiency, that is, the heat generation can be reduced as much as possible. Since the drive circuit has been already described with reference to FIG. 5, this description is omitted here.

In FIG. 16, the kind of the glass substrate 50 is not limited particularly to B boro-silicate glass or vitreous silica. However, the kind in good in smoothness and thermal conductivity is preferable. Further, in place of the glass substrate 50, for example, a plastic substrate is used. On a surface of the glass substrate 50 or the plastic board in place of the glass substrate 50 where the organic electroluminescence element 63 is formed, a barrier layer formed of silicon oxide or the like is preferably provided so as to prevent the organic electroluminescence element 63 from receiving damage by water that has passed through the substrate.

A numeral 112 is an anode, which uses a transparent electrode in the embodiment. As material of the anode 112, ITO (Indium Tin Oxide) which is a substantially transparent oxide electroconductor or IZO (Indium Zinc Oxide) are usually used. However, the material of the anode is not limited to this.

A numeral 118 is a pixel regulating part. In the organic electroluminescence element 63 constituting the exposure unit 13 (refer to FIG. 3) in the embodiment, the area of a luminous area LA of the organic electroluminescence element 63 is regulated by the pixel regulating part 118. The pixel regulating part 118 is composed of a substantial insulating matter. The pixel regulating part 118 can be readily manufactured by spin-coating with a photosensitive resin such as polyimide and by a photo lithography process. Further, the pixel regulating part 118 can be formed, after the anode 112 has been formed, by use of inorganic compounds, for example, insulating inorganic oxide and nitride, or oxygen nitride such as SiO₂, SiN, TiO₂, and TiN.

Since the inorganic compounds are good in insulating property and high in pressure-resistance, it is more preferable that the inorganic compounds are used in the pixel regulating part 118 than the organic compounds. Particularly, in case that the thickness of the pixel regulating part 118 is set to 50 nm or less, the film thickness distribution in case that the emission layer 114 is formed by means of the ink jet process or the spin coating method is improved greatly. Hereby, film thickness uniformity of the emission layer 114 in the luminous area LA becomes good, and the lifetime of the organic electroluminescence element 63 is also improved more than the lifetime thereof in case that the pixel regulating part 118 is thick.

As described later in detail, in the embodiment, by the pixel regulating part 118, the area of the luminous area LA of the organic electroluminescence element 63 is set to at least 25 μm² and at most 10000 μm².

A numeral 130 is an hole injection layer. The hole injection layer 130 has a function of injecting the hole in the emission layer 114 from the anode 112 formed of ITO efficiently. As the hole injection layer 130, specifically, PEDT by Bayer which is representative is used, in which a polythiophene group or a polyaniline group is dispersed in water soluble polymer material. This layer can be formed by the spin-coat method, the printing method, or the ink jet method. Further, inorganic oxides of which V₂O₅, MoO₃, WO₃, and NiO are representative show good hole injection performance; In this case, the layer can be formed by a dry process such as vacuum deposition or sputtering. To provide this inorganic oxide on the anode 112 makes the lifetime of the organic electroluminescence element 63 longer than to use the hole injection layer using an organic semiconductor which the above PEDT is representative of, so that the use of the inorganic oxide is particularly preferable to show advantages of the invention.

A numeral 131 is an electron block layer. The electron block layer 131 has a function of preventing the electron injected from the cathode 116 from arriving at the anode 112 without forming an exciton. In this case, the LUTMO level of the electron block material must be higher than the LUMO level of the light emission layer 114, and it is preferable that in order to inject the hole into the light emission layer 114, the HOMO level or work function of the electron block material is on the same level as that of the anode 112 and that of the light emission layer 114. As compounds having such the properties, there are used polyfluorene-based compounds such as poly-[9, 8-dioctylfluorene-co-N-(4-butylphenyl)-diphenylamine]. Provision of this electron block layer 131 may improve luminous efficacy and the lifetime of the organic electroluminescence element 63 by selection of the luminous material. However, the electron block layer 131 is not indispensable for the invention.

A numeral 114 is a light emission layer. In the organic electroluminescence element 63 in the embodiment, the light emission layer 114 is formed mainly of polymer luminous material. As this polymer luminous material, polyfluorene based- and polyphenylene-vinylene based-compounds are representative. However, various luminous materials which have been known in well-known patent documents can be used in principle, for example, dendorimer-type luminous material, pendant-type polymer material which has a light emission part in side chain, family in which luminous material is doped in polymer matrix, and the like.

A numeral 116 is a cathode. The cathode 116 uses frequently metal, metal oxide, or halide compounds, which has low work function in order to perform electron injection from the cathode 116 with good efficiency. As material of the cathode 116, there are preferably used alkaline metals such as barium, calcium, lithium, and cesium; and halide compounds and oxides such as lithium fluoride, cesium fluoride, barium oxide, and the like. Since these materials are unstable, their upper portions are covered with comparatively stable material which has larger work function. In case that light is taken out from the anode 112 side, as the cathode 116, the material which is high in reflectivity, such as silver, aluminum, or the like is generally used. On the other hand, light can be taken out also from the cathode 116 side. In this case, the metal is made very thin to provide light transmission, or a transparent electrode such as ITO may be used.

The organic electroluminescence element 63 having such the structure, as oxygen or water enters the inside of the light emission layer 114, is immediately put in a non-luminous state. In order to prevent this non-luminous state, it is necessary to seal the organic electroluminescence element 63 immediately after the manufacture. The sealing method can use well-known methods. Namely, there are a method of coating organic electroluminescence element 63 with resin which suppresses water transmission and covering the upside of its resin layer with glass or metal, a method of forming a resin and inorganic compounds continuously in vacuum without breaking the vacuum after the cathode 116 has been formed thereby to form a protection layer of several μm, ant the like. In the exposure unit according to the invention, any methods may be adopted.

In the embodiment, in the exposure unit 13 (refer to FIG. 3) using the organic electroluminescence element 63 as the light source, the area of the luminous area LA of the organic electroluminescence element 63 is set to at least 25 μm² and at most 10000 μm² per pixel, and the power to be inputted in the organic electroluminescence element 63 is set to at least 3.5 W/cm² and at most 100 W/42.3 μm per pixel.

As described before, in the exposure unit 13 (refer to FIG. 3) in the embodiment, the resolution in the main scanning direction is set to 600 dpi. At this time, the organic electroluminescence elements 63 which are the exposure sources are arranged at 42.3 μm pitches, and one side of each organic electroluminescence element 63 is about 37 μm. The area of this light emitting element is 1369 μm². The shape of the organic electroluminescence element 63 may be circular, and the area in this case becomes 1075 μm². Both areas satisfy the above size condition.

A manufacturing process of the organic electroluminescence element 63 of the exposure unit 13 in the embodiment, and a result of performance evaluation thereof will be described below in detail.

The glass substrate 50 with ITO, which was previously etched and cleaned sufficiently, was coated with photo regist material as the pixel regulating part 118 with thickness of 2 μm, the coated glass substrate 50 was exposed to the light through a photo mask prepared separately, and the organic electroluminescence elements 63 having the luminous areas LA sizes of 200 μm square, 100 μm square, 40 μm square, 20 μm square, and 8 μm square per pixel were formed. Next, as the hole injection layer, PEDT (by Bayer) of the thickness of 500 nm was formed by spin-coating and dried. Next, the electron block layer 131 was formed by spin-coating so that its dry film thickness becomes 20 nm, and similarly dried. Thereafter, red light emission polymer material having a maximum luminous wavelength of 650 nm was applied similarly by spin-coating so that its film thickness becomes 700 mn, and dried, whereby the light emission layer 114 was formed. Next, barium was deposited on the light emission layer 114 as the cathode 116, and thereafter silver was deposited. The formed specimen was sealed by UV resin and flat glass (both are not shown) which were low in water transmission.

In case that the organic electroluminescence element 63 is used as the light source of the exposure unit in the electrophotographic apparatus, matching with sensitivity characteristic (sensitivity characteristic for wavelength) described later of the photoconductor 8 (refer to FIG. 3) is important. In view of replacement in the electrophotographic apparatus which has used the semiconductor laser diode as the exposure source, setting a peak wavelength of the exposure light emitted from the organic electroluminescence elements 63 to at least 600 nm and at most 800 nm secures matching on sensitivity for the exposure wavelength to the existing photoconductor, and particularly to an organic photoconductor (so-called OPC, which is referred to as a digital photoconductor since a latent image is formed by writing by a semiconductor laser).

Regarding the thus obtained specimens, the drive current values were adjusted so that initial luminance became nearly the same among the respective specimens, and a lifetime test was performed in DC drive. The lifetime is herein defined as time when the drive at the constant initial luminance can be performed no more. Namely, the light quantity was monitored by the photodiode, and when the luminance was lower than the initial setting luminance by 2%, the electric current and the voltage were adjusted so that the luminance became the initial setting luminance. As light emission is thus observed continuously at the constant luminance, the limit time when the initial setting luminance cannot be kept even in case that the electric current and the voltage are increased more comes. In the embodiment, this time is defined as the lifetime.

Therefore, the electric power inputted in the organic electroluminescence element 63 in the light emission time changes greatly from the initial power to the last input power at the time of the lifetime. In measurement of the emission luminance, BM-5 by TOPCON was used. Further, in measurement of the luminous energy, CS1000 by MINOLTA was used, and the luminous energy was measured simultaneously with the emission luminance. Further, the power inputted in the organic electroluminescence element 63, by means of “236 source major unit” by Keithley Instruments Inc. which is a meter which can perform application and measurement of the voltage or the electric current simultaneously, was adjusted, whereby the voltage and electric current (that is, input power) for driving the organic electroluminescence element 63 was controlled as preciously as possible. This result will be indicated in Table 1.

TABLE 1

| | Initial | | | | | | | |
|---|---|---|---|---|---|---|---|---|
| | Input | | | | | | | |
| Luminance | power | Luminous area per pixel | | | | | | |
| Cd/m² | W/cm² | 200 μm × 200 μm | 100 μm × 100 μm | 40 μm × 40 μm | 20 μm × 20 μm | 8 μm × 8 μm | 5 μm × 5 μm | 3 μm × 3 μm |
| 2000 | 2 | 150 hr | 150 hr | 160 hr | 160 hr | 165 hr | 167 hr | 108 hr |
| 5000 | 3.5 | 30 hr | 80 hr | 100 hr | 110 hr | 120 hr | 123 hr | 85 hr |
| 10000 | 8 | 5 hr | 18 hr | 20 hr | 23 hr | 25 hr | 26 hr | No |
| | | | | | | | | data |
| 15000 | 12 | 2 hr | 12 hr | 19 hr | 19 hr | 20 hr | 22 hr | No |
| | | | | | | | | data |

As clear from the Table 1, in the specimen having the luminous area LA of 200 μm square per pixel, the lifetime is short. On the other hand, in the specimens having the luminous areas LA of 100 μm square (that is, the area of the luminous area of 10000 μm²) or less per pixel, there is an effect in improvement of the lifetime, and it is known that till the luminous area LA is 5 μm square (that is, the area of the luminous area is 25 μm²), there is the effect in improvement of the lifetime. However, when the luminous area LA came further to 3 μm square, at least in the DC drive, the element entered the non-luminous state in a very short time such as tens minutes, and the significant data could not be obtained.

As described before, in case that the photoconductor is exposed to the red light, the emitted light quantity necessary for the organic electroluminescence element 63 is about 2000 cd/m². However, this emitted light quantity is the lowest level, and in order to obtain an output image of high quality, it is necessary to form an electrostatic latent image which is large in contrast on the photoconductor 8. Considering this formation, it is necessary to cause the organic electroluminescence element 63 to emit the light with the emitted light quantity of about 5000 cd/m².

As shown in the Table 1, the initial input power in this case was 3.5 W/cm² per pixel. The last input power at the time of lifetime of the organic electroluminescence element 63 defined above was nearly 100 W/cm² per pixel regardless of the initial luminance.

In the embodiment, as specification of the electrophotographic apparatus on which the exposure unit is mounted, it is assumed that paper speed is 20 ppm (this is under the group from a low-speed machine to a middle-speed machine). For example, in case of a high-speed machine of 40 ppm, the emitted light quantity of 5000 cd/m² makes the formation of the latent image which is large in contrast on the photoconductor 8 difficult, so that the organic electroluminescence element 63 requires very high emission luminance such as about 10000 cd/m². In this case, as corresponding means, the initial input power is set to 8 W/cm² per pixel.

Next, the valuation was performed in pulse drive. As pulse drive conditions, the organic electroluminescence element 63 was put in an ON state for 340 μs and caused to emit the light, and thereafter, the electric current was made off for 20 μs. In the current OFF time, the cathode 116 and the anode 112 were short-circuited, and the electric charges stored in the organic electroluminescence element 63 were eliminated.

This result will be indicated in Table 2. As clear from the Table 2, the lifetime is improved more in all the conditions than that in case of DC drive. It is found that particularly in the element having the luminous region LA of 100 μm or less square per pixel, degree of the improvement is large.

TABLE 2

| | Initial | | | | | | | |
|---|---|---|---|---|---|---|---|---|
| | Input | | | | | | | |
| Luminance | power | Luminous area per pixel | | | | | | |
| Cd/m² | W/cm² | 200 μm × 200 μm | 100 μm × 100 μm | 40 μm × 40 μm | 20 μm × 20 μm | 8 μm × 8 μm | 5 μm × 5 μm | 3 μm × 3 μm |
| 2000 | 2 | 170 hr | 170 hr | 195 hr | 220 hr | 225 hr | 215 hr | 98 hr |
| 5000 | 3.5 | 42 hr | 85 hr | 120 hr | 120 hr | 125 hr | 120 hr | 40 hr |
| 10000 | 8 | 5.5 hr | 20 hr | 30 hr | 35 hr | 40 hr | 41 hr | 30 hr |
| 15000 | 12 | 2.5 hr | 15 hr | 25 hr | 29 hr | 28 hr | 24 hr | 8 hr |

As described later, the organic electroluminescence element 63 in the invention can select as the luminous material either of polymeric type and low-molecular type. These detailed materials and layer constitution can be seen in the latest monograph. They are described in, for example, “Organic EL Handbook” published in 2004 under the supervision of Tetsuo Tsutsui, by Realize Advanced Technology Ltd., or in SID Seminar Lecture Notes, on May, 2005.

Regarding the polymeric type electroluminescence element of their types, it is thought that since the layer constitution is simple and mass-production by the coating method is possible, a device of low cost can be realized. Therefore, the polymeric type electroluminescence element is noticeable, but it has been generally said that this element is shorter in drive lifetime than the low-molecular type electroluminescence element. However, as described with reference to Table 1 and Table 2, the effect of regulating the luminous area LA of the organic electroluminescence element 63 and the drive power of the organic electroluminescence element 63 give the polymeric type electroluminescence element a large effect of improving its lifetime.

Next, except that the PEDT was removed and MoO3 was vacuum-deposited as the hole injection layer 130 so the layer thickness became 50 nm, the elements were similarly manufactured. The lifetimes of the obtained organic electroluminescence elements 63 were evaluated similarly in the DC drive, with the result that their lifetimes became five times larger than the lifetimes of the organic electroluminescence elements 63 using the PEDT. Particularly, the higher the luminance was, that is, the higher the input power was, the larger the effect of the lifetime improvement was than that of the organic electroluminescence element 63 using the PEDT.

The drive method of the organic electroluminescence element 63 in the embodiment will be described below more detailedly.

The drive method of the organic electroluminescence element 63 is divided roughly into active drive and passive drive. Since the organic electroluminescence element 63 in the embodiment emits high luminous energy with very high efficiency, in case that the organic electroluminescence elements 63 are arranged and driven, it is preferable that the active drive method in which a switching transistor is provided for each element and the light emission can be controlled individually is used in order to prevent an excessive load on the emission luminance. Of the active drive methods, a method using a so-called thin film transistor has been known. As the thin film transistor, an amorphous silicon transistor substrate and a low temperature polysilicon transistor substrate have been known. In case that the organic electroluminescence element 63 in the embodiment is used in the exposure unit, higher electron mobility is required because of the request of printing speed. Therefore, it is particularly preferable that the polysilicon transistor substrate in which at least the mobility is about 100 cm/V is used. Further, in case that the higher printing speed is required, division drive can correspond to the improvement of the printing speed.

Further, though the drive of the organic electroluminescence element 63 is generally performed at constant current, there is no harm in constant-voltage drive.

Though the organic electroluminescence element 63 in the embodiment is greatly improved in its lifetime, the emission luminance lowers with the passage of the drive time. In the exposure unit 13 (refer to FIG. 3) using such the organic electroluminescence element 63 as the light source, in order to measure the emitted light quantity of each organic electroluminescence element 63 for this lowering of emission luminance, the before-described light quantity measuring part is provided, which senses the light quantity, that is, emission energy. It is necessary for formation of a stable image to keep the energy emitted to the photoconductor 8 constant. Since the constitution and operation of the light measuring part have been already described, their description is omitted here.

Another mode of the organic electroluminescence element in the embodiment will be described below with reference to FIG. 1.

In the below-described mode, the material constituting the light emission layer 114 of the organic electroluminescence element 63 and a manufacturing process of the organic electroluminescence element 63 are only changed, and the constitutions of the glass substrate 50 on which the organic electroluminescence elements 63 are formed, the exposure unit 13 (refer to FIG. 3) provided with this glass substrate 50, and the image forming apparatus 1 on which this exposure unit 13 is mounted are entirely the same as those described before. Therefore, their description is omitted.

A manufacturing process of the organic electroluminescence element 63 will be described below. In the following description, the light emission layer 114 constituting the organic electroluminescence element 63 is composed mainly of low-molecular luminous material.

Specimens of the element sizes having the luminous areas LA sizes of 200 μm square, 100 μm square, 40 μm square, 20 μm square, and 8 μm square per pixel were manufactured by means of low-molecular family deposition material. Namely, on an etched ITO substrate, carbon is sputtered with thickness of 10 nm as the hole injection layer 130. Thereafter, triphenyl amine-based compound (α-NPB) was deposited with thickness of 40 nm also as the hole injection layer 130. Next, as the light emission layer 114, AIq₃ was used as host material, and DCM was used as a red dopant.

As the cathode 116, LiF and Al were deposited respectively with thickness of 5 nm and thickness of 150 mn. Thereafter, sealing was performed and a lifetime evaluation 10 was performed. The lifetime evaluation was performed in the before-mentioned pulse drive, and conditions of the used meters and the like are equivalent to the before-mentioned conditions. A result of evaluation will be shown in Table 3.

TABLE 3

| | Initial | | | | | | | |
|---|---|---|---|---|---|---|---|---|
| | Input | | | | | | | |
| Luminance | power | Luminous area per pixel | | | | | | |
| Cd/m² | W/cm² | 200 μm × 200 μm | 100 μm × 100 μm | 40 μm × 40 μm | 20 μm × 20 μm | 8 μm × 8 μm | 5 μm × 5 μm | 3 μm × 3 μm |
| 2000 | 2.4 | 120 hr | 125 hr | 180 hr | 200 hr | 200 hr | 205 hr | 120 hr |
| 5000 | 4.2 | 40 hr | 75 hr | 100 hr | 100 hr | 120 hr | 122 hr | 60 hr |
| 10000 | 8.5 | 7 hr | 25 hr | 36 hr | 37 hr | 43 hr | 40 hr | 18 hr |
| 15000 | 13.5 | 4 hr | 20 hr | 25 hr | 30 hr | 30 hr | 24 hr | 12 hr |

The definition of the lifetime is similar to the definition which has been already described.

As known from the Table 3, also in case that the light emission layer 114 of the organic electroluminescence element 63 is formed of the low-molecular luminous material, the effect of the invention is noticeable.

Further, as clear from the Table 3, the specimens adjusted to the element sizes indicated in the embodiment, in case that the initial luminance is set to 5000 cd/m² or more, is particularly noticeable in effect of lifetime improvement.

Though these reasons have not been clear at the present time, both of the low-molecular material and the polymer material show very remarkable results. According to the invention, the organic electroluminescence element 63 which is very high in luminous efficacy and has a long lifetime can be realized.

### Second Embodiment

A second embodiment of the invention will be described below with reference to drawings.

FIG. 13 shows the constitution of an exposure unit 13 in an image forming apparatus according to the second embodiment of the invention. Components of the image forming apparatus which will not be particularly described below, for example, the whole constitution of the image forming apparatus and the like, are common to those in the image forming apparatus according to the first embodiment. Therefore, their description is omitted.

The exposure unit 13 in FIG. 13 includes a glass substrate 50, a lens array 51, a relay board 52, a connector A53a, a connector B53b, a housing A54a, a housing B54b, and a cooling unit 150.

The cooling unit 150 is used in order to cool an organic electroluminescence element 63 and a light receiving element (both are not shown in FIG. 13) which have been formed on a surface A of the glass substrate 50, and is composed of, for example, a Peltier element. The cooling unit 150 is fixed on the upper portions of these structures formed on the glass substrate 50 by, for example, an adhesive.

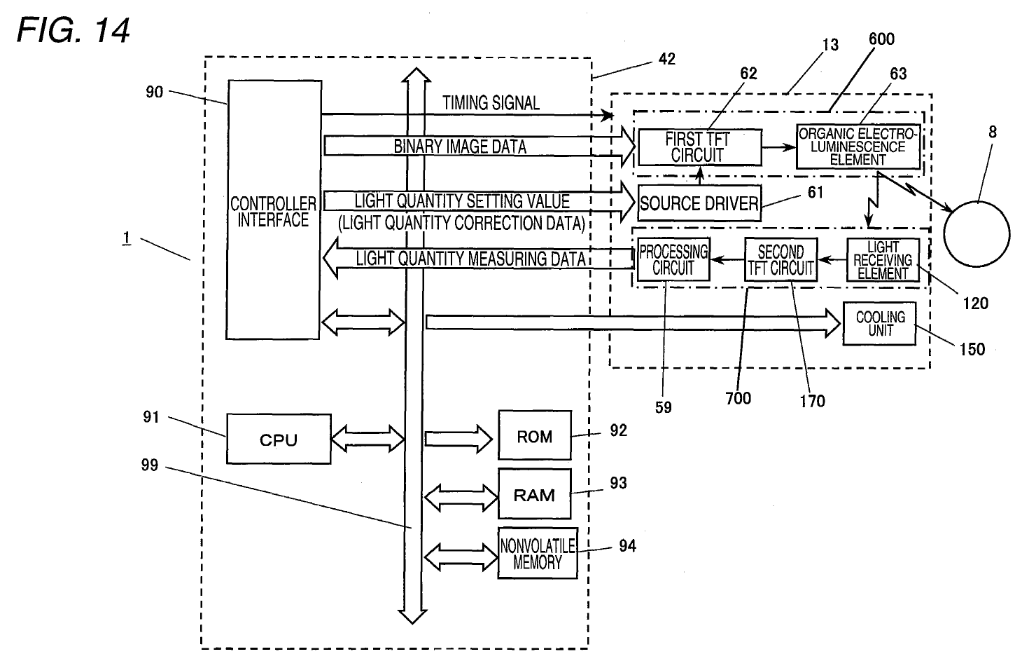

FIG. 14 is a block diagram showing the constitution of an engine control part 42 in the image forming apparatus according to the second embodiment of the invention. The engine control part 42 in FIG. 14 corresponds to the engine control part 42 in the first embodiment, and it is partially omitted. With reference to FIG. 14, a process of controlling the temperature of the light receiving element 120 in the second embodiment will be described below in detail. The matter described in the second embodiment is applied to a case where the increase rate of sensitivity of the light receiving element 120 with the temperature increase exceeds the increase rate of sensitivity of the photoconductor 8.

Photocurrent caused by the light receiving element 120 is passed to a processing circuit 59 by a second TFT circuit 170. The constitution of the processing circuit 59 is the same as that in the first embodiment. In the processing circuit 59, similarly to the case in the first embodiment, light quantity measuring data is generated through steps of voltage conversion, offset adjustment, and amplification, and passed once to a controller interface 90. However, the processing circuit 59 is different in setting of amplification factor from that in the first embodiment.

Referring also to FIG. 8, the description will be continued below. In the first embodiment, the amplification factor of the amplifier 177 is set to the “value by which a difference in temperature characteristic between the light receiving element 120 constituting the light quantity measuring part and the photoconductor 8 can be reduced” and the “value by which the input dynamic range of the A/D converter 179 is sufficiently secured for change in the emitted light quantity from the initial state to the lifetime expiration of the organic electroluminescence element 63”. However, in the second embodiment, it is enough that the amplification factor of an amplifier 177 is set to a “value by which an input dynamic range of an A/D converter 179 is sufficiently secured for change in the emitted light quantity from the initial state to the lifetime expiration of the organic electroluminescence element 63”. Namely, in the second embodiment, the processing circuit 59 does need to have a function of a characteristic difference correcting part.

Turning to FIG. 14, the description will be continued below. The light quantity measuring data passed to the controller interface 90 is passed to an engine control CPU 91 by a bus 99 of the engine control part 42. The engine control CPU 91, in the light quantity measuring time in the operation of initialization and in the light quantity measuring time in the paper interval period, monitors the light quantity measuring data for the specified organic electroluminescence element 63. When the sensitivity of the light receiving element 120 increases with the increase of the inside temperature of the image forming apparatus 1, the engine control CPU 91 can recognize this increase of sensitivity from the value of the monitored light quantity measuring data. In case that the engine control CPU 91 judges that the temperature increase of the light receiving element 120 exceeds the predetermined value, it controls ON of the cooling unit 150 formed of, for example, the Peltier element.

A cooling object of the cooling unit 150 is actually not only the light receiving element 120 but also the whole of the glass substrate 50 (refer to FIG. 13) on which the light receiving element 120 is formed. Therefore, though it is necessary to determine cooling capacity of the cooling unit 150 by heat capacity of the whole of the glass substrate 50, the cooling capacity of such a degree that the temperature increase of the light receiving element 120 is made gentler than the temperature increase of the photoconductor 8 is enough. As described before, the second embodiment is applied to the case where the increase rate of sensitivity of the light receiving element 120 with the temperature increase exceeds the increase rate of sensitivity of the photoconductor 8. Therefore, by making the temperature change of the light receiving element 120 smaller than the temperature change of the photoconductor 8, it is possible to reduce variations in image density due to the difference in the temperature characteristic. Here, it is a point to be emphasized that the essence of the invention is not to control the temperature of the light receiving element 120 constantly by the cooling unit 150 but to provide a temperature difference between the photoconductor 8 and the light receiving element 120 in order to reduce the temperature characteristic difference between them. Hereby, the temperature characteristic difference between them is reduced. In this point, strictness is not required for the control, so that the second embodiment is advantage in cost. As described above, the temperature of the light receiving element 120 is controlled by the engine control CPU 91 and the cooling unit 150.

In the above description, the function of the characteristic difference correcting part is not given to the processing circuit 59. However, since the temperature difference between the photoconductor 8 and the light receiving element 120 is previously measured readily in the operating state of the image forming apparatus 1, also in the second embodiment, by adjusting the amplification factor of the processing circuit 59 as described in the first embodiment, the temperature characteristic difference between them can reduced more positively.

Further, in the image forming apparatus shown in FIGS. 13 and 14, though the control of the cooling unit 150 is performed through the engine control CPU 91, by giving the temperature difference to one of the light receiving element 120 and the photoconductor 8 which are placed under the nearly same atmospheric temperature, the difference between the both temperature characteristics can be reduced. Therefore, the cooling unit 150 may be so constructed that ON-control is performed when the power is applied to the image forming apparatus 1. Further, though the Peltier element is used as the cooling unit 150 in the description, this cooling unit may use a heat transmitter such as a heat pipe, or a heat transmission sheet formed of, for example, carbon, or may be composed of what cools the exposure unit 13 selectively from the outside, such as a fan.

The above description, as described before, is applied to the case where the increase rate of sensitivity of the light receiving element 120 with the temperature increase exceeds the increase rate of sensitivity of the photoconductor 8. In this case, by making the temperature increase of the light receiving element 120 gentler than the temperature increase of the photoconductor 8, the difference between the both temperature characteristics is reduced. The same effect as this effect can be achieved also by mounting a heater in the photoconductor 8.

To the contrary, in case that the increase rate of sensitivity of the light receiving element 120 with the temperature increase is smaller than the increase rate of sensitivity of the photoconductor 8, the heater is provided for the exposure unit 13 or the cooling unit is provided for the photoconductor 8 by means of the similar constitution to the aforesaid constitution, whereby the difference between the both temperature characteristics can reduced.

An exposure unit has also been known, which has plural light emitting element arrays in which each light emitting element array is composed of organic electroluminescence elements, and performs exposure steps of plural times in the nearly same position in the rotational direction of a photoconductor, thereby to form a latent image. The invention can be readily applied also to such the exposure unit.

As described above, though in the first embodiment and the second embodiment, the image forming apparatus which uses the electrophotographic process has been described, the invention is not limited to the electrophotography. Since a RGB light source can be readily realized by the organic electroluminescence elements, the invention can be readily applied also to an image forming apparatus in which plural exposure units each having a R light source, a G light source, or B light source as an exposure source are arranged and photographic paper is directly exposed to light on the basis of image data of each color of RGB.

The invention is available to an image forming apparatus which can form an image uniformly regardless of change in surrounding temperature, such as a printer, a copying machine, a facsimile device, a photoprinter, or the like.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based upon and claims the benefit of priorities of Japanese Patent Application No. 2006-034832 filed on Feb. 13, 2006 and No. 2006-123750 filed on Apr. 27, 2006, the contents of which are incorporated herein by reference in its entirety.

What is claimed is:

1. An image forming apparatus comprising:
an image bearing body which bears an image to be formed by exposure;
a light emission part which emits light for exposing the image bearing body to the light;
a light quantity measuring part which measures the quantity of the light emitted by the light emission part and outputs a light quantity measuring signal; and
a correction part which corrects the light quantity measuring signal so as to reduce a difference between a change rate of the image density of the image bearing body for temperature, and a change rate of the light quantity measuring signal of the light quantity measuring part for temperature.

2. An image forming apparatus comprising:
an image bearing body which bears an image to be formed by exposure;
a light emission part which emits light for exposing the image bearing body to the light;
a light quantity measuring part which measures the quantity of the light emitted by the light emission part and outputs a light quantity measuring signal; and
a light quantity control part which controls the quantity of the light emitted by the light emission part so that a value of the light quantity measuring signal outputted by the light quantity measuring part becomes a predetermined value,
wherein the image bearing body and the light quantity measuring part are constituted so that temperature characteristics of them are offset by each other.

3. An image forming apparatus comprising:
an image bearing body which bears an image to be formed by exposure;
a light emission part which emits light for exposing the image bearing body to the light;
a light quantity measuring part which measures the quantity of the light emitted by the light emission part and outputs a light quantity measuring signal; and
a light quantity control part which controls the quantity of the light emitted by the light emission part so that a value of the light quantity measuring signal outputted by the light quantity measuring part becomes a predetermined value,
wherein a sign indicating a change rate of the light quantity measuring signal of the light quantity measuring part for temperature coincides with a sign indicating a change rate of the density of a picture image formed by the image born by the image bearing body for temperature.

4. The image forming apparatus according to claim 2, wherein the light quantity measuring part includes a light receiving element which receives the light emitted by the light emission part and converts its light into an electric signal; and
a sign indicating a change rate of the electric signal of the light receiving element for temperature coincides with a sign indicating a change rate of the density of a picture image formed by the image born by the image bearing body for temperature.

5. The image forming apparatus according to claim 2, wherein the light quantity measuring part includes a correction part which corrects a difference between temperature characteristic of the light quantity measuring part and temperature characteristic of the image bearing body; and
between a change rate of the image density of the image bearing body for temperature, and a change rate of the light quantity measuring signal of the light quantity measuring part for temperature.

6. The image forming apparatus according to claim 1, wherein the light quantity measuring part includes a light receiving element which receives the light emitted by the light emission part and converts its light into an electric signal; and
the correction part corrects the electric signal so as to reduce a difference between a change rate of the image density of the image bearing body for temperature, and a change rate of the electric signal of the light receiving element for temperature.

7. The image forming apparatus according to claim 6, wherein the correction part performs offset adjustment and level conversion of the electric signal.

8. The image forming apparatus according to claim 1, comprising a measuring part temperature control part which controls temperature of the light quantity measuring part.

9. The image forming apparatus according to claim 1, comprising an image bearing body temperature control part which controls temperature of the image bearing body.

10. The image forming apparatus according to claim 1, comprising a temperature difference reducing part which reduces a temperature difference between the image bearing body and the light quantity measuring part.

11. The image forming apparatus according to claim 10, including an exposure unit having at least the light emission part and the light quantity measuring part, wherein the temperature difference reducing part is formed by a protrusion part provided for the exposure unit.

12. The image forming apparatus according to claim 1, wherein the light emission part is formed of an organic electroluminescence element.

13. The image forming apparatus according to claim 12, wherein the area of a luminous area of the organic electroluminescence element is set to at least 25 m² and at most 1000 m² per pixel; and
electric power applied to the organic electroluminescence element is set to at least 3.5 W/cm² and at most 100 W/cm² per pixel.
